(19) United States
(12) Patent Application Publication
(10) Pub. No.: US 2011/0307105 A1
(43) Pub. Date: Dec. 15, 2011

(54) Custom clamps for deep-sea oil containment

(76) Inventor: Frederic G. Commoner, Brighton, MA (US)

(21) Appl. No.: 13/134,379

(22) Filed: Jun. 6, 2011

Related U.S. Application Data
(60) Provisional application No. 61/397,288, filed on Jun. 9, 2010.

(51) Int. Cl. G05D 7/00; G05B 15/02; B25B 1/00

(52) U.S. Cl. 700/282; 269/86; 700/275

(57) ABSTRACT

A custom-manufactured clamshell plumbing fixture, or clamp, is provided, which precisely fits the irregular surface of a damaged oil-well riser pipe, or the surface of a blow-out-preventer, so as to tightly seal oil leaks. Using an optional gasket, the fixture functions as a plumbing adaptor with the damaged pipe at one joint, and a standard plumbing flange at another joint. Because of its rigid mechanical connection to the damaged pipe, a clamp of similar manufacture can also provide a solid platform for machine tools, allowing for reliable, precise cuts in damaged pipe or other devices, using a remote-controlled milling machine. The custom clamps are manufactured using techniques of digital object-capture and computer-controlled metal-working. Methods are discussed which can help to determine the exact shape of the surface to be sealed, and to manufacture and install the clamps and gaskets.

### CROSS-REFERENCE TO RELATED APPLICATIONS

This application claims the benefit of provisional patent application Ser. No. 61/397,288, filed on Jun. 9, 2010 by the present inventor.

### FIELD OF THE INVENTION

The present invention relates to the containment of deep-sea oil leaks, and more particularly, to oil-containment devices which provide a tight seal with broken or irregularly-shaped pipes, or other irregular surfaces.

### REFERENCE DOCUMENTS

The following table lists some documents which may be relevant to the understanding of the prior art in the field of the present invention.

US Patents

| U.S. Pat. No. | Kind Code | Issue Date | Inventor |
|---|---|---|---|
| 3,770,301 | B1 | Nov. 6, 1973 | Adams |
| 4,535,822 | B1 | Aug. 20, 1985 | Rogers |
| 4,611,485 | B1 | Sep. 16, 1986 | Leslie |
| 5,090,742 | B1 | Feb. 25, 1992 | Cohen et al. |
| 5,226,492 | B1 | Jul. 13, 1993 | Solaeche et al. |
| 5,358,286 | B1 | Oct. 25, 1994 | Eaton et al. |
| 5,689,862 | B1 | Nov. 25, 1997 | Hayes et al. |
| 5,918,639 | B1 | Jul. 6, 1999 | Ottestad et al. |
| 6,612,341 | B2 | Sep. 2, 2003 | Vu |
| 6,971,413 | B2 | Dec. 6, 2005 | Taylor |
| 6,802,375 | B2 | Oct. 12, 2004 | Bosma et al. |
| 7,591,491 | B2 | Sep. 22, 2009 | Lizenby et al. |

US Patent Application Publications

| Pub. No. | Kind Code | Pub. Date | Inventor |
|---|---|---|---|
| US 2010/0314870 | A1 | Dec. 16, 2010 | Cromarty |

European Patent Application Publications

| Doc. Number | Kind Code | Pub Date | Inventor |
|---|---|---|---|
| EP 00779465 | A1 | Jun. 18, 1997 | Bennett et al. |

### OTHER PUBLICATIONS

[Cameron] “Considering Technical Options for controlling the BP blowout in the Gulf of Mexico”, James Cameron's Ad Hoc Deep Ocean Group, Jun. 1, 2010. http://www.whoi.edu/fileserver.do?id=64963&pt=10&p=44453
[Hammer] “Discovery of second pipe in Deepwater Horizon riser stirs debate among experts”, David Hammer, The Times-Picayune, Jul. 9, 2010. http://www.nola.com/news/gulf-oil-spill/index.ssf/2010/07/post_{—}19.html
[Hofmeister] “Oil Spill Deals Gulf Coast a Summer of Misery” Interview with John Hofmeister, CBS/AP news report, May 31, 2010. http://www.cbsnews.com/stories/2010/05/31/national/main6534391.shtml/
[Mowbray] “BP removes containment cap in preparation for method that could contain more oil”, Rebecca Mowbray, The Times-Picayune, Jul. 10, 2010. http://www.nola.com/news/gulf-oil-spill/index.ssf/2010/07/bp_removes_containment_cap_in.html
[OSC Working Paper 6] “Stopping the Spill—The Five-Month Effort to Kill the Macondo Well”, National Commission on the BP Deepwater Horizon Oil Spill and Offshore Drilling, Staff Working Paper No. 6., Jan. 11, 2011. http://www.oilspillcommission.gov/sites/default/files/documents/Updated%20Containme nt%20Working%20Paper.pdf
[OSC Recommendations] “Deep Water—The Gulf Oil Disaster and the Future of Offshore Drilling—Recommendations”, National Commission on the BP Deepwater Horizon Oil Spill and Offshore Drilling, January 2011. http://www.oilspillcommission.gov/sites/default/files/documents/OSC_Deep_Water_Su mmary_Recommendations_FINAL.pdf
[Wells] “BP Kent Wells Technical Briefing Transcript”, BP, Jul. 10, 2010. http://www.bp.com/liveassets/bp_internet/globalbp/globalbp_uk_english/gom_response/STAGING/local_assets/downloads_pdfs/kent_wells_presentation_transcript_{—}07_{—}10_{—}2010.pdf

### BACKGROUND

1. Discussion of the Prior Art

On the night of Apr. 20, 2010, a catastrophic and deadly explosion occurred at the Deepwater Horizon oil well in the Gulf of Mexico, breaking the well's riser pipe, and causing what would become the petroleum industry's largest accidental release of oil into the oceans.

After failed efforts to stop the leak by activating the well's blow-out preventer (BOP), attention turned to the well's riser pipe, which had detached from the drilling rig when the rig sank. In addition to the oil leak from the broken end of the riser, a second leak was found in a bent portion of the riser, near the riser's intact connection to the BOP. [1]

Attempts were made to contain or capture the oil flow from the broken end of the riser pipe. A containment dome was tried first, [2] followed by the Riser Insertion Tube Tool, a device which was inserted into the end of the riser pipe. [3] Neither of these approaches was able to achieve a tight seal with the broken pipe.

After the failure of these methods, the riser was cut just above the BOP on June 2, and an oil containment cap called the “top hat” was installed on June 3, hooking onto the top flange of the BOP. Like the previous attempts, however, the top hat was not tightly sealed. As a result, oil continued to flow into the Gulf for weeks afterwards. Only when a tightly-sealed cap was placed over the BOP on July 15 was the oil flow finally stopped.

These events called the world's attention to the fact that, in an accident of this kind, a tightly-sealed attachment site for an oil-containment device is a matter of critical importance.

2. The Lack of Prior Art

Before the capping of the Deepwater Horizon, there really wasn't much established prior art in stopping oil spills 5000 feet deep in the ocean. Industry and government experts interviewed by the National Oil Spill Commission agreed that relief wells were “the only accepted, high-probability solution to a subsea blowout, even though they take months to drill.” [4]

Consider the following quotes from the January 2011 report of the National Oil Spill Commission:
The most obvious, immediately consequential, and plainly frustrating shortcoming of the oil spill response set in motion by the events of Apr. 20, 2010 was the simple inability—of BP, of the federal government, or of any other potential intervener—to contain the flow of oil from the damaged Macondo well. [5]
Clearly, improving the technologies and methods available to cap or control a failed well in the extreme conditions thousands of feet below the sea is critical to restoring the public's confidence that deepwater oil and gas production can continue, and even expand into new areas, in a manner that does not pose unacceptable risks of another disaster. [6]
Beyond attempting to close the blowout preventer stack, no proven options for rapid source control in deepwater existed when the blowout occurred. BP's Initial Exploration Plan for the area that included the Macondo prospect identified only one response option by name: a relief well, which would take months to drill. Although BP was able to develop new source-control technologies in a compressed timeframe, the containment effort would have benefited from prior preparation and contingency planning. [7]

Faced with a lack of proven methods, BP was forced to improvise. The techniques they used in an attempt to capture oil directly from the damaged riser pipes were not successful in the essential goal of achieving a tight seal. However, as it happens, there are a number of prior art inventions that do propose to seal broken, damaged, or leaky pipes. Could such devices have been used to seal the damaged riser pipe of the Deepwater Horizon (DH) well? Let's examine these approaches and see what conclusions we can draw about their applicability in the crisis under consideration.

### Stoppers and Clamps

One form of leak-stoppage device is a cylindrical plug or stopper that is inserted into the pipe. (See, for example, the patents of Leslie, and of Solaeche et al, listed in the above references.) For these kind of fixtures to work as intended, they must fit accurately into the pipe which they are meant to seal. But that kind of good fit may not have been a possibility in the DH well riser. The broken end of the riser pipe may have been pinched, cracked, or distorted. Under these conditions, it's not clear that a simple cylindrical plug, even with gaskets and/or resins to help it seal, would have been a realistic option. Beyond that, inserting a plug into a pipe, especially a pinched or bent pipe, is not something that is easy for remotely-operated vehicles (ROVs) to do. Besides, the second of the two leaks in the riser was a crack in the pipe, not a full open end. Plugs and stoppers can't be used in a leak of that kind

In another form of leak-stopping device, a clamp, or clamshell-type device, is positioned around the leaking pipe, and then tightened. When closed, the clamps enclose a fixed cylindrical region meant to match and seal the surface of the leaking pipe. Some of these (such as those of Rogers and Cromarty) rely on metal-to-metal contact alone to effect a seal. Other devices seek to enhance the sealing capacity of the clamp by the use of gaskets, liners, pads, tampers, or “muffs”, made from elastomers, polymers, or other resilient materials. (As in the respective inventions of Cohen, Eaton, Hayes, Ottestad, and Taylor.) A number of the referenced inventions also use liquid sealants, resins, or grouts in addition to a mechanical device. (Such as Adams, Eaton, Vu, and Bennett)

Even with gaskets or resins, if a pipe is highly irregular, a clamp that doesn't match it isn't going to work too well. In some cases, the force applied to the clamp could squeeze the pipe into the right shape to be sealed, but force at that level could also break the pipe and make things worse. Thus, as with plugs and stoppers, we see that clamps are really only of use when the distortions of the target pipe from its normal cylindrical shape are small enough to be handled with gaskets and/or resins.

Ideally, one would like to have a clamp that would be a perfect fit for the damaged pipe, whatever the condition and geometric shape of that pipe may be. But that would require some method of custom fitting which could be adapted to pipes that were significantly distorted from their original round shape. We find no evidence of that kind of custom fitting technology in the prior art.

Fluids, of course, have the advantage of forming themselves to the shape of a surface that surrounds them. Some approaches, such as the invention of Bosma, use resins alone as a means for sealing leaks. However, resins are very tricky to use in the ocean depths, and all the more so when applied by means of ROVs. Unless a team has trained thoroughly for the use of resins, it would be preferable to use an approach that requires only the more simple kinds of ROV actions. An even more basic problem is that, when using resins alone, fluid pressure is a major consideration. The pressure of leaking oil could simply push resins out of the way, preventing the formation of a true seal.

Examining these inventions, we arrive at the conclusion that they would, in all likelihood, not have been suitable for capping the DH well. The fact that these approaches were not attempted by the best team of experts the nation could assemble lends support to this view.

The crucial limitation of these methods is that none of them combines the following two essential features that would be needed to form a tight seal against distorted pipes: (1) The ability to adapt to the geometry of the surface to be sealed, and (2) the ability to withstand substantial fluid pressure.

But what sort of technology could provide both of these two capabilities? The eventual successful capping of the DH well doesn't provide an answer, because it was achieved by exposing a standard flange. (See discussion below.) In effect, the problem of irregular surfaces was circumvented, rather than confronted directly. In the event of another blowout however, one in which it may be risky or impossible to expose a flange on the BOP, we may find ourselves in urgent need of a means to create a tight seal with irregular surfaces.

### Methods Used By BP

As we have seen, when the Deepwater Horizon blowout occurred, there were no established options for rapidly stopping a deep-sea oil-well leak. What this means is that much of the prior art in this matter, if there is any, is to be found in the rapidly improvised solutions which BP, together with experts from the U.S. Coast Guard, the Department of Energy, the National Labs, and other groups, were able to fashion over the course of the emergency.

The exact details of what they did and how they did it have not, at this writing, been made fully public. However, it is possible to piece together a partial account of the various attempts they made, both unsuccessful, and, in time, successful, in order to stop the leak.

### Cutting Tools

On June 2, after the failure of the “top kill” operation, BP tried to use a diamond saw to make a clean cut in the riser pipe, just above the BOP. [8] The hope was that getting a clean, flat cut in the riser would allow a tight seal with the planned top hat cap. This illustrates once again that there was a lack of methods for sealing directly to irregular surfaces. It was understood that a tight seal would require a precise flat surface, hence the need for a precise cut.

The cutting procedure did not succeed, however, because the saw became jammed in the riser pipe. BP had to settle for a more jagged cut, made with a huge pair of shears. The lack of a clean cut was clearly a significant factor in the failure of the top hat, once it was installed, to form a tight seal with the surface of the cut-off riser.

This failure calls attention to another significant limitation in the prior art—an inability to reliably make precise metal cuts in deep water. In order to make a precise cut in a metal object, a rigid, stable mechanical relationship must be established between that object and the cutting tool which is to be used. There are indications that the sawing machine used by BP in their attempt to cut the riser pipe may not have had such a rigid, stable mounting. This could have contributed to the jamming of the saw blade.

Actually though, in general, saw blades are more likely to jam than are milling bits, because milling bits can respond to side pressure from the surrounding material by cutting into that material. Moreover, even when jammed, milling bits are easier to extricate or replace; this can even be done in an ROV-manageable way.

We don't know why BP didn't use a milling machine to make the cut on the riser, rather than a saw. What is clear, however, in hindsight, is that a milling device, if available, would have been a better, lower-risk choice, and the use of a milling device should be planned in anticipation of future emergencies of this kind. Milling machines require a very firm connection to the material to be worked. Establishing such a firm connection with damaged, irregular pipe, however, involves a similar problem to the one faced in trying to make a fluid-tight seal with such an object. Because of the object's irregular shape, some customized or adaptive attachment device would be required.

In fact, BP's diamond saw assembly did have a device of that general kind, a mechanical means of grabbing onto the pipe, in the form of a claw-like hydraulic gripper. Photos and video records of the use of the diamond saw, however, suggest that this gripper was not really capable of establishing the kind of truly solid attachment that would be required if milling tools were to be used.

### Attachment to the Top Flange

When BP finally managed to seal the leak on the Deepwater Horizon well, they did so by removing the top flange on the BOP, and attaching a tight-sealing cap to the bottom flange. In view of the lack of other known techniques which had a good chance of working, that eventual success is perhaps the single most important element of the prior art.

Anyone who knows even a little about industrial plumbing realizes that a standard plumbing flange, with its flat surface, and its standardized mounting holes, can be used to create a tight seal. From the earliest days of the spill, confusion and frustration emerged from the fact that everyone could see, in the live video feed of the leaking well, a two-part pipe flange fixture at the top of the BOP. People wanted to know, why can't you just take off the top half of that flange, and attach a tight-fitting device onto the remaining bottom half?

This seemed like a sensible suggestion, and it is also, in essence, what was eventually done with success. In fact, investigators have reported that this option was discussed internally by BP within a week of the blowout. [9]

But early on, there is strong evidence to suggest that BP and other experts were not sure if the top half of the flange could be removed at all, or if it could be done safely. This kind of thing had never been attempted in deep water, and BP had no established procedure for doing it. [10][11]

Moreover, there may have been concerns about whether removing the top flange would damage the BOP, and make things a lot worse. Experts had realized that the BOP may have already been damaged during the accident, in both known and unknown ways. [12] It was not known how delicate it might be. In an effort to understand what had occurred within the BOP, and what was its current inner state, gamma ray scans were undertaken, at the suggestion of Secretary of Energy Steven Chu, in mid-May. [13]

There are reports that, during this period, suggestions by BP and other contributors for how to seal the leak were carefully scrutinized by scientists from three DOE national laboratories. [14][15] Particular attention was given to interventions that might be too intrusive on the BOP, or on the surrounding rock, running the risk of making things worse. [16]

Complicating matters, it was revealed around July 9 that there were not just one but two drill pipes trapped inside the BOP. This discovery had been a surprise to BP, and further raised worries, by both experts and the public, that the true state of things inside the BOP was not fully understood. [17] There may also have been concerns that the trapped drill pipes, being in contact with both the top flange and the partially shut-off area within the BOP, might make it dangerous to shift the position of the top flange.

The removal of the top flange was finally carried out after diligent preparation and scrutiny. It was a highly complex procedure. [18] Hydraulic jacks were used to straighten the flex joint just under the top flange, which had been bent 3 degrees during the original accident. [19] BP wasn't sure they would actually be able to unbolt the flange at all. As a back-up plan, they had built a flange-splitting tool capable of using hydraulic rams to force the two halves of the flange apart. [20]

Careful planning and practice had been required to try to assure that the operations were safe, and that they could be performed by the ROVs which were available.

What this makes clear, in our view, is that it would be valuable to have some kind of fixture or device which could be used to attach a tight-sealing cap in a manner which would be fast, ROV-friendly, and non-intrusive with respect to the interior state of the BOP. If possible, this attachment should be designed so that it can be carried out without the need for the complex, potentially risky process required to take apart the top flange of the damaged BOP.

If a tight-sealing cap could have been installed early enough, most of the oil that entered the Gulf could have been captured, preventing billions of dollars in damages to the economy and environment of the Gulf Coast.

But how could this have been done? One option would have been to somehow attach tightly-sealed devices onto the broken portions of the riser pipe, before that pipe was eventually cut off close to the BOP. A solution of this kind would not have required removing the top flange of the BOP, and would have created minimal disturbance to the BOP. Another option would have been to somehow attach a tightly-sealed device onto the BOP, without removing the flange. Like attachment to damaged pipe, this approach would require an ability to produce a tight seal against a surface that is potentially irregular and not initially designed to be part of a sealed plumbing joint.

### Conclusions

Summarizing then, we see that (1) there is no applicable technique found in the prior art which permits attachment onto severely distorted riser pipe, or a similar irregular surface, (2) a comparable lack of technique may also exist in the matter of rigidly attaching machine-tool platforms onto irregular surfaces, so as to facilitate precise cuts of damaged pipes, and (3) the flange removal process, while it has the potential of giving a tight seal, involves intruding into an unknown state of the BOP, and thus carries with it significant risks of damaging the BOP and thereby making the leak worse.

In a May 2010 interview, John Hofmeister, former president of Shell Oil, called for a “paradigm shift” in how the oil-spill crisis response was being conceptualized and managed. [21] It is clear that, if our nation is again faced with such a catastrophe, we will need radical new ways of dealing with it, based on ideas and technology that go far beyond what was available during the course of the Deepwater Horizon oil spill. We believe that the present invention provides exactly this kind of innovation, and does so in a way that addresses critical shortcomings of the prior art.

### Notes

[1] OSC Working Paper 6, page 5.
[2] Ibid., p 9.
[3] Ibid., p 12.
[4] Ibid. p 5.
[5] OSC Recommendations, p 31.
[6] Loc. cit.
[7] Ibid., p 32.
[8] OSC Working Paper 6, p 22
[9] Ibid., p 26.
[10] Ibid., p 1.
[11] OSC Recommendations, p 32.
[12] Cameron pp 11-12.
[13] OSC Working Paper 6, pp 8, 15.
[14] Ibid., pp 13-14, 24, 27,
[15] OSC Recommendations, p 32.
[16] OSC Working Paper 6, pp 17, 24, 27.
[17] Hammer, p 1.
[18] OSC Working Paper 6, p 28.
[19] Mowbray, p 2.
[20] Wells, p 4.
[21] Hofmeister, p 2.

### SUMMARY

In accordance with the present invention, there is provided a clamshell-type multi-piece clamp which can be rapidly custom-manufactured in order to precisely fit the distorted or irregular surface of a damaged riser pipe, or the surface of a portion of a BOP. By creating a tight seal between this clamp and such a surface, an oil leak may be fully contained. Such containment is achieved by fabricating the clamp in a shape which, once assembled, functions as a plumbing fixture which seals with the damaged pipe at one joint, and provides a standard plumbing flange at another joint.

Because of its rigid and sturdy mechanical connection to the damaged pipe, a clamp of similar manufacture can also be fabricated so as to provide a platform for machine tools, sufficiently solid and rigid so as to allow for reliable, precise cuts in damaged pipe. Clamps with this purpose and function are another provision of the present invention.

There is further provided an optional matching, custom-manufactured gasket which can be used along with the clamp to achieve a tight seal against oil leakage, and/or a firm mechanical connection with the target object.

There are also provided a number of methods and processes to facilitate the determination of the exact shape of the surface to be sealed, the manufacturing of the clamps and gaskets, and the successful installation of the clamps and gaskets.

### Advantages

It is an object of the invention to enable the sealing of deep-water oil leaks from damaged or distorted pipes, or other fluid-carrying equipment whose connection capacity has been compromised.

Another object of the invention is to provide for the rigid connection of tooling platforms to such damaged equipment, in order to permit precise cuts to be made on it, so as to aid in the fluid-tight attachment of various oil-containment devices.

It is also an object of the invention to allow for the use of a milling machine, as an alternative to a saw, in order to make precise, reliable, cuts in damaged pipes or other equipment, and to do so in a jamming-resistant way, in response to an oil-spill or similar emergency.

Another object of the invention is to reduce the risk of further damage to a damaged BOP by permitting the capping of a BOP without the need to make intrusive emergency BOP modifications, such as the removal of parts.

An additional object of the invention is to provide an oil-containment process which is ROV-friendly, in the sense that it can be easily performed by underwater Remotely Operated Vehicles.

Finally, it is also an object of the invention to encourage the establishment of emergency manufacturing facilities, emergency response teams, and other forms of preparedness, so as to make it easier for emergency responders to practice oil containment procedures in advance, with the goals of reducing risk and response time during an emergency, and also of facilitating interoperability between different emergency response organizations.

### BRIEF DESCRIPTION OF THE DRAWINGS

29 drawings on 21 sheets are included.

FIG. 1 is a perspective view of a broken pipe, showing an area where a clamp device may be attached.

FIG. 2 is a perspective view of the pipe attachment area seen in FIG. 1, also including a cross-section.

FIG. 3 is a perspective drawing which shows how a digital model of the geometry of a pipe may be obtained by laser scanning.

FIG. 4 is a perspective view of a 2-piece custom-manufactured clamp designed to fit around the pipe attachment region shown in FIG. 2, and scanned in FIG. 3.

FIG. 5 is a side view of the clamp of FIG. 4 in place around the target pipe, showing how the clamp matches the irregular shape of the pipe.

FIG. 5A is a side view of the clamp of FIG. 4 in place around the target pipe, illustrating the use of a gasket.

FIG. 5B is a side view of the clamp of FIG. 4 in place around the target pipe, illustrating the use of a gasket with extension flaps.

FIG. 6 is a perspective view showing the clamp of FIG. 4 in place around the target pipe.

FIG. 6A is a perspective view of a clamp similar to that of FIG. 6, showing how such a clamp can be used to provide a rigid platform for a cutting tool, permitting accurate cuts to be made in the target pipe.

FIG. 7 is a perspective view of a leaking pipe.

FIG. 8 is a perspective view of a custom 2-piece “containment” clamp which encapsulates the leaking pipe of FIG. 7 in such a way that the leak can be capped by the attachment of a standard plumbing fixture to the clamp.

FIG. 8A is a perspective view of a custom 2-piece clamp used to join two damaged pipes together in a fluid-tight way, without the need to attach standard plumbing flanges to the pipes.

FIG. 9 shows a custom clamp attached to the broken pipe first seen in FIG. 1, in such a way that oil leaking from the pipe can be contained by attaching a standard plumbing fixture to the clamp.

FIG. 10A is a cross-section view of a pipe containing a cavity which cannot be easily matched with a custom-made clamp.

FIG. 10B shows a custom clamp which wraps around the pipe seen in FIG. 10A but fails to seal the surface of the cavity.

FIG. 10C shows a schematic perspective view of the pipe of FIG. 10A, illustrating why the clamp seen in FIG. 10B would fail to create a fluid-tight seal, when used in a containment clamp similar to the ones shown in FIGS. 8, 8A, and 9.

FIG. 11 is a perspective view of the top joint of the Deepwater Horizon BOP, illustrating possible regions where a containment clamp might be attached to it.

FIG. 12A is a side view of the top joint of the BOP seen in FIG. 11, showing a cross-section of a containment clamp which attaches to the remnant of the cut-off riser pipe.

FIG. 12B is a side view of the top joint of the BOP seen in FIG. 11, showing a cross-section of a containment clamp which attaches to the outer edge of the flange.

FIG. 12C is a side view of the top joint of the BOP seen in FIG. 11, showing a cross-section of a containment clamp which attaches to both the remnant of the riser pipe, and the outer edge of the flange.

FIG. 13A is a perspective view of a containment clamp for the top joint of the BOP, using the attachment idea illustrated in FIG. 12C. It includes a cut-away revealing a cross-section of the lower part of the clamp.

FIG. 13B is a perspective view, with two cross-sections, showing greater details of the geometry of the clamp of FIG. 13A.

FIG. 13C is a perspective view of a containment clamp similar to the one shown in

FIG. 13A, with that clamp now installed on the top joint of the BOP, supported by a framework of girders.

FIG. 14 is an end view of an object which may be impossible to cover with a 2-piece clamp. A 3-piece clamp which covers the object is seen in cross-section.

FIG. 15 is a perspective view of a 3-piece clamp on a piece of undamaged pipe, also showing a cross-section of the pipe.

FIG. 15A is a planar diagram showing how the edges of a 180° plate, this plate being part of a 2-plate clamp, may be prone to scraping and jamming, due the tangential movement of those edges as the plate is installed on the target pipe.

FIG. 15B is a planar diagram showing how the edges of a 120° plate, this plate being part of a 3-plate clamp, have a lower risk of scraping and jamming, due to the 30° angle they make in their installation motion, relative to the target pipe's tangent plane.

FIG. 16 is a perspective view of a 3-plate containment clamp which fits on the same leaking pipe shown in FIGS. 7 and 8.

FIG. 17 is a perspective view of a 3-piece clamp with two matching curved flanges, also showing a cross-section of the enclosed pipe.

### REFERENCE NUMBERS FOR THE DRAWINGS

The following tabulation is a list of numbered parts appearing in the figures. The number or part code is shown in the first column, followed by a description of the item. The Figures column is a list of the figures in which that item is marked. In cases where there are too many figures to fit in the column, the list of figures is shown on the next line of the table.

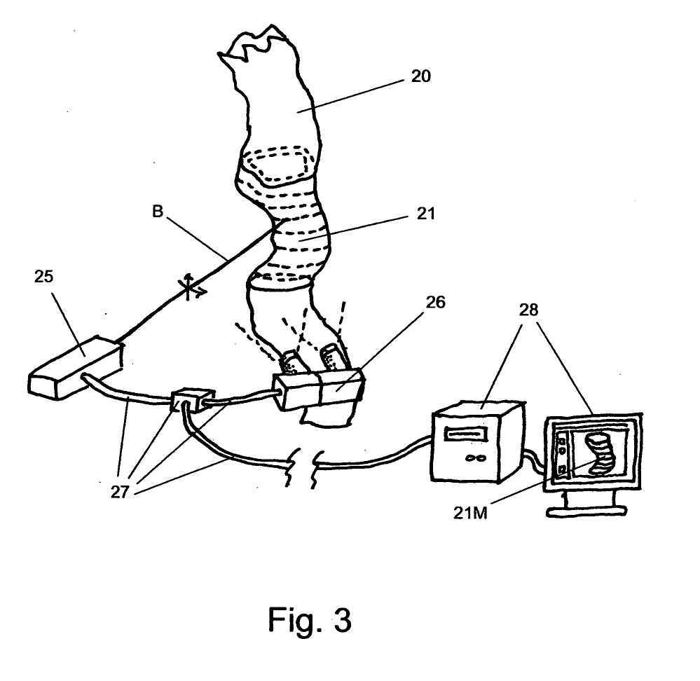

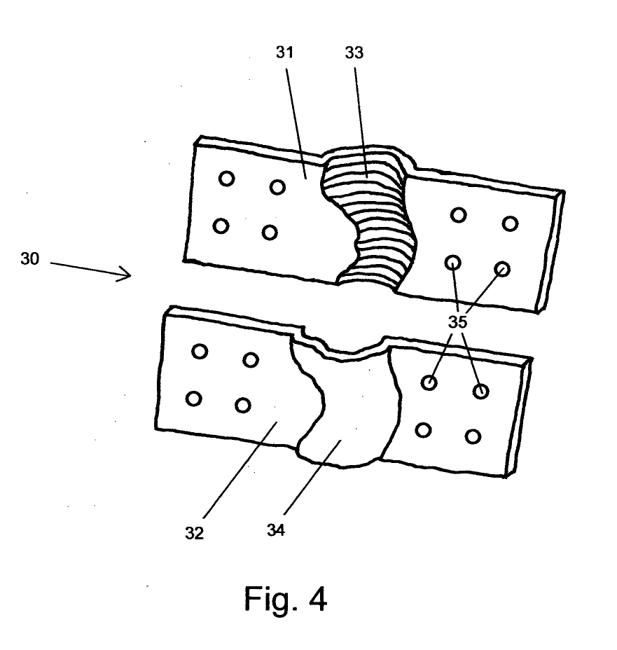

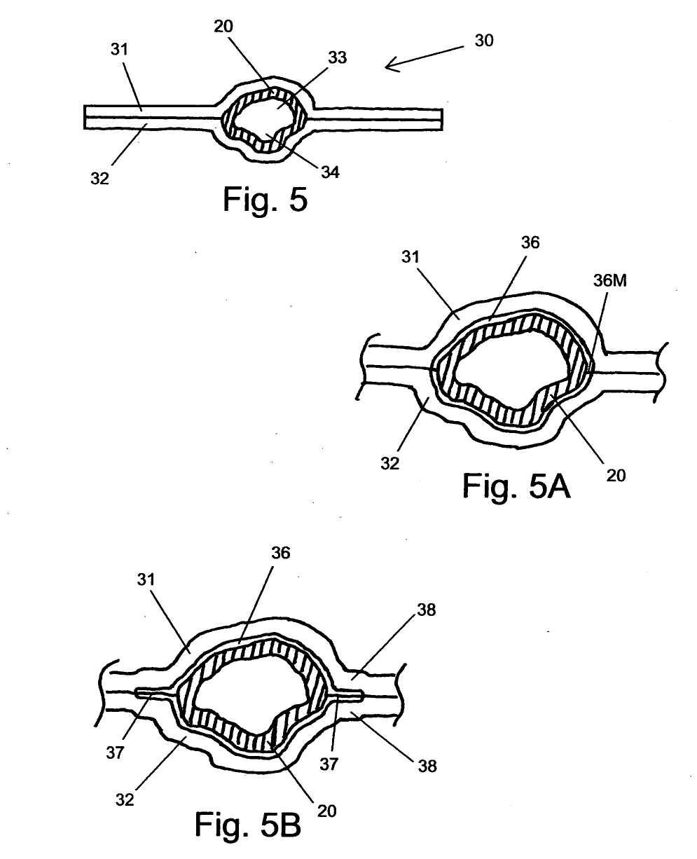

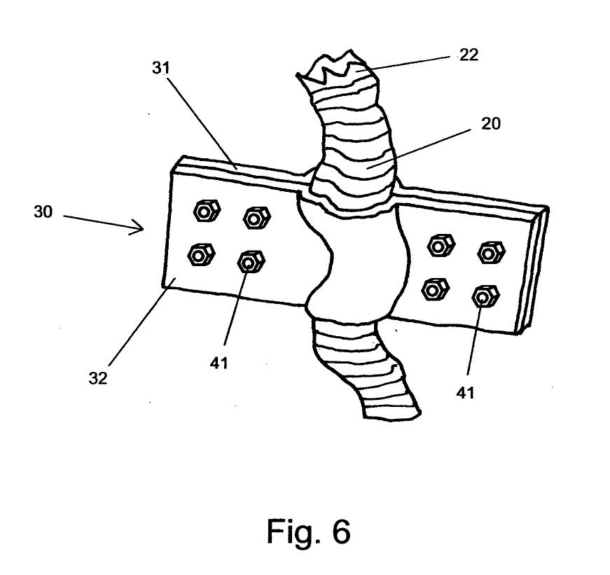

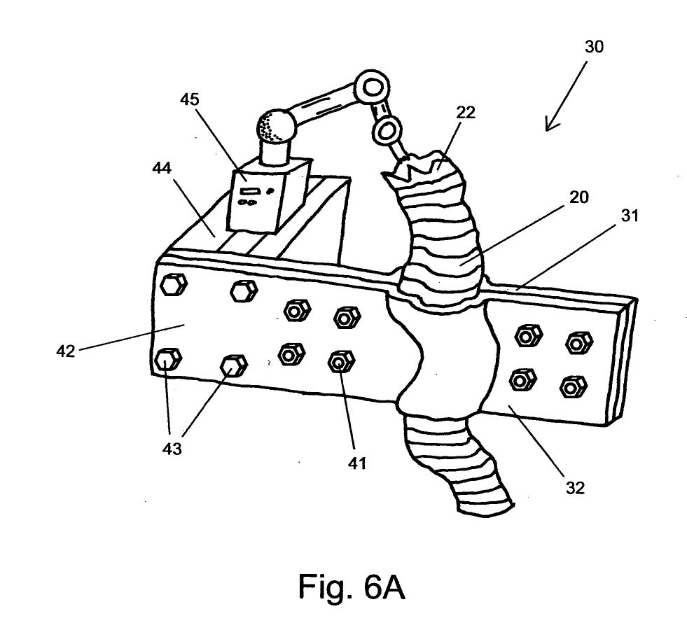

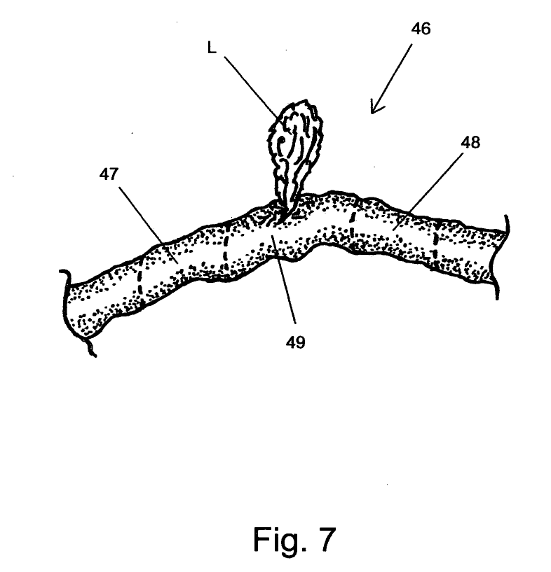

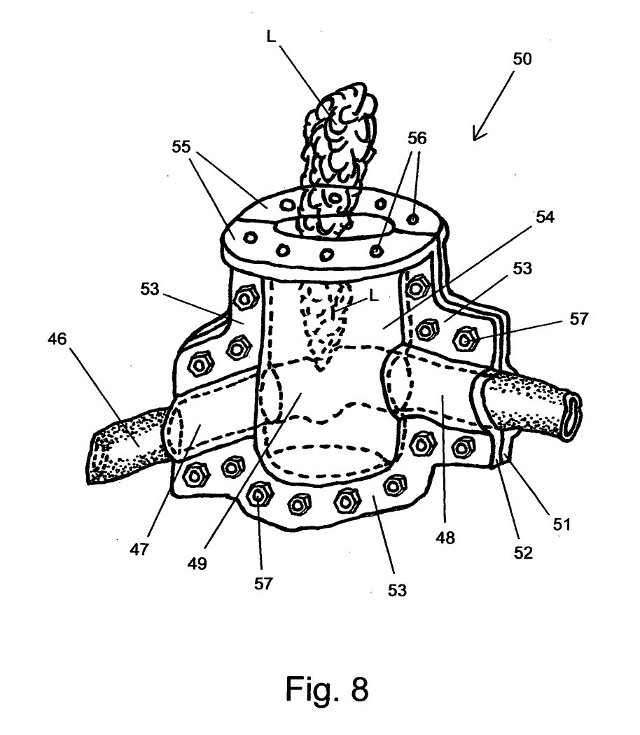

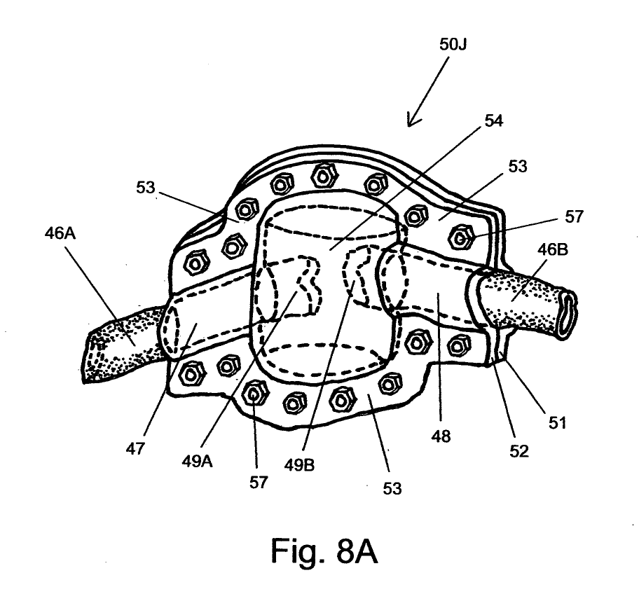

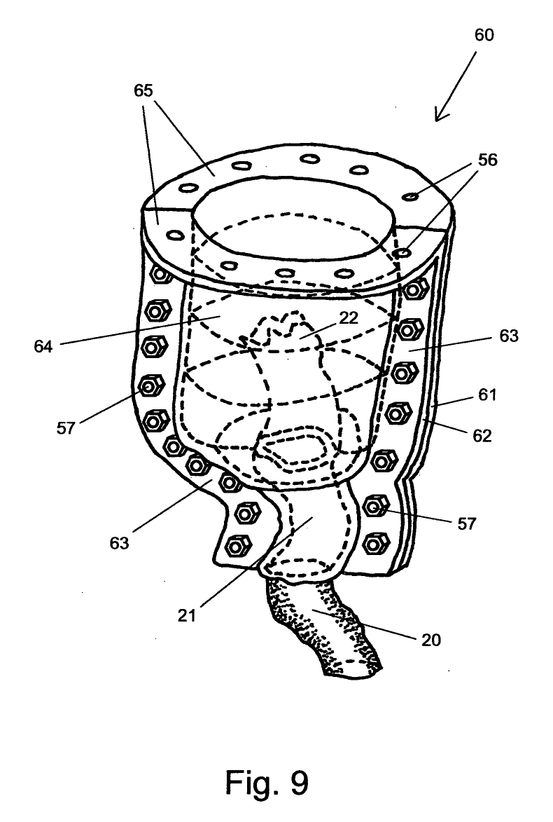

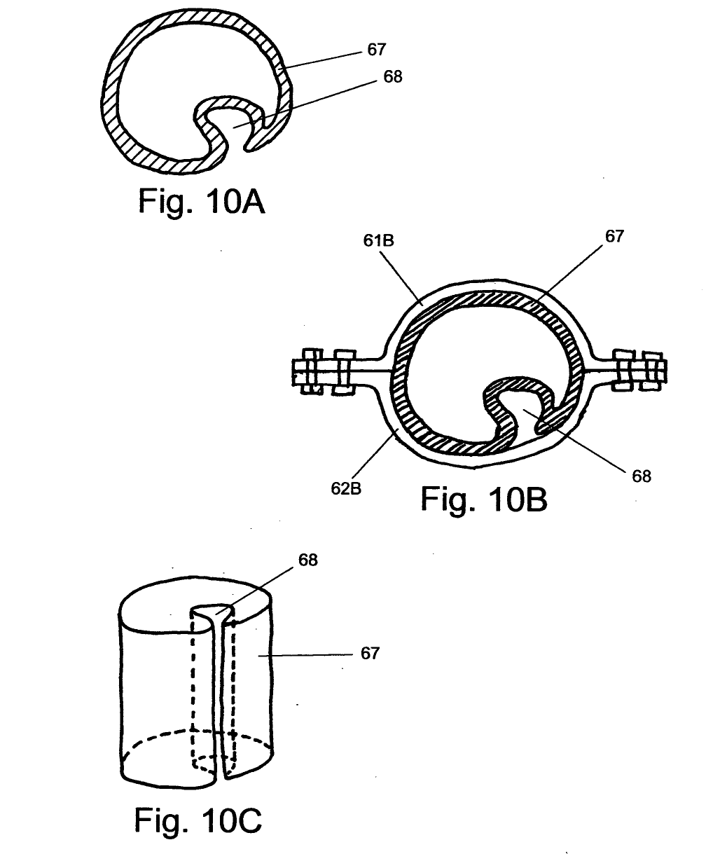

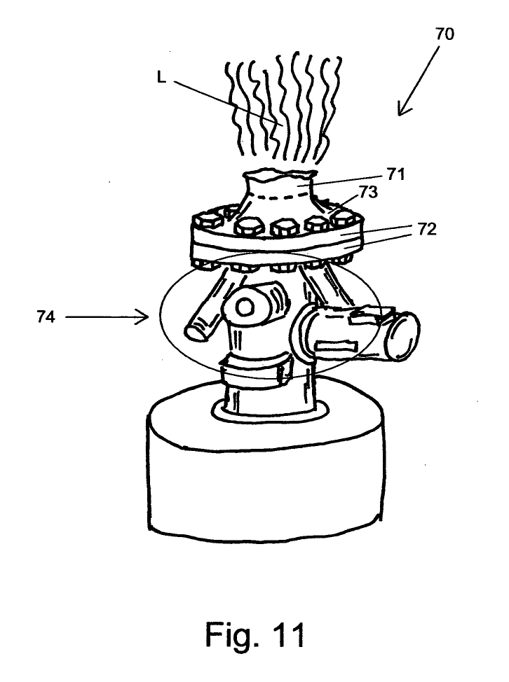

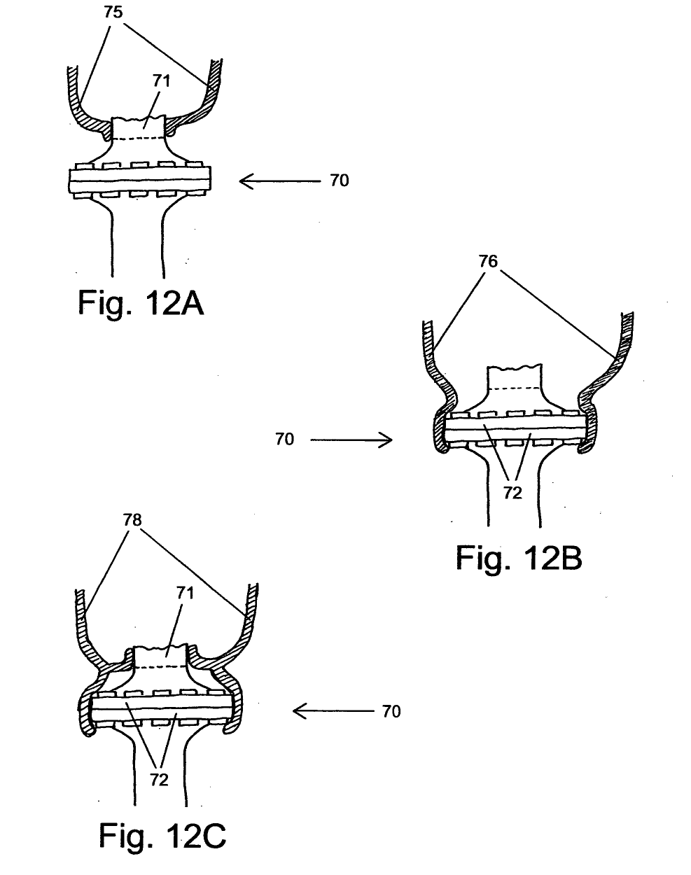

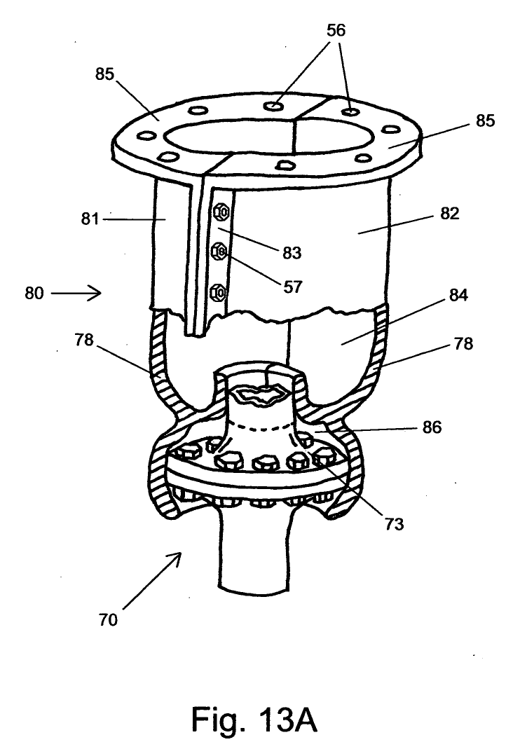

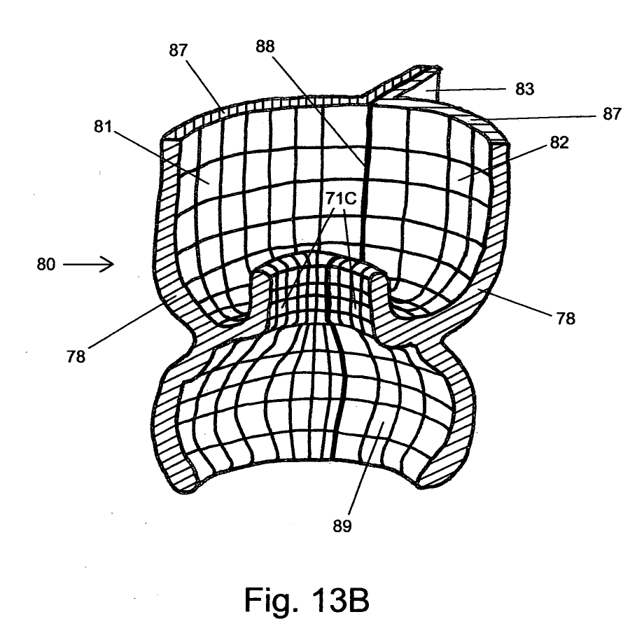

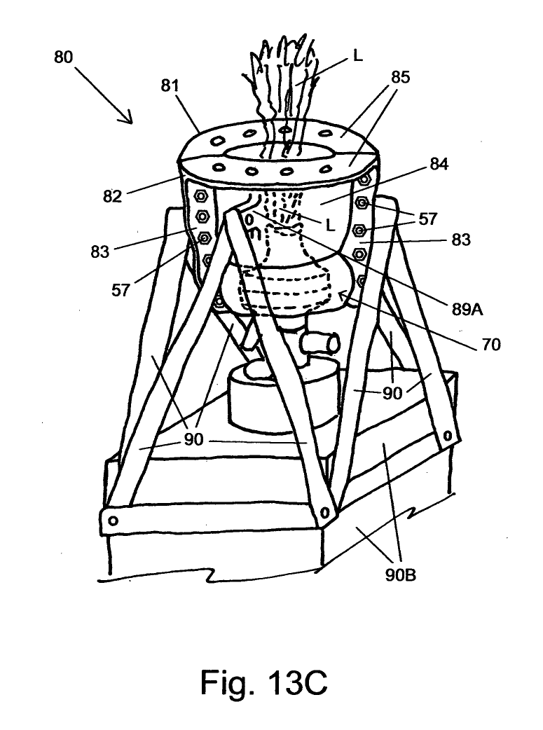

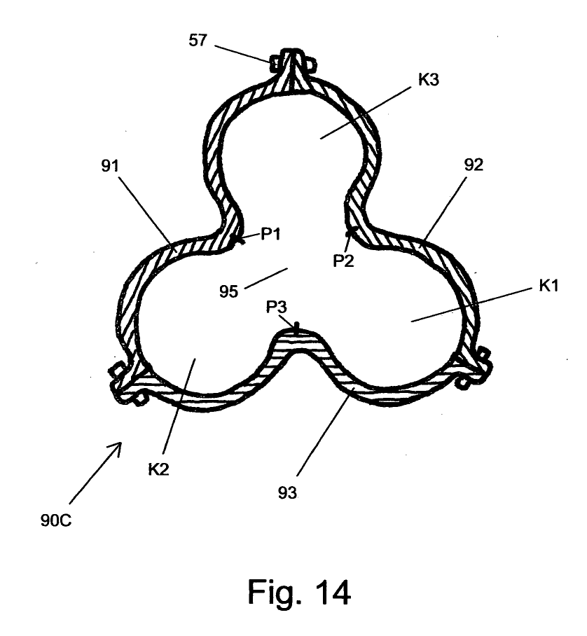

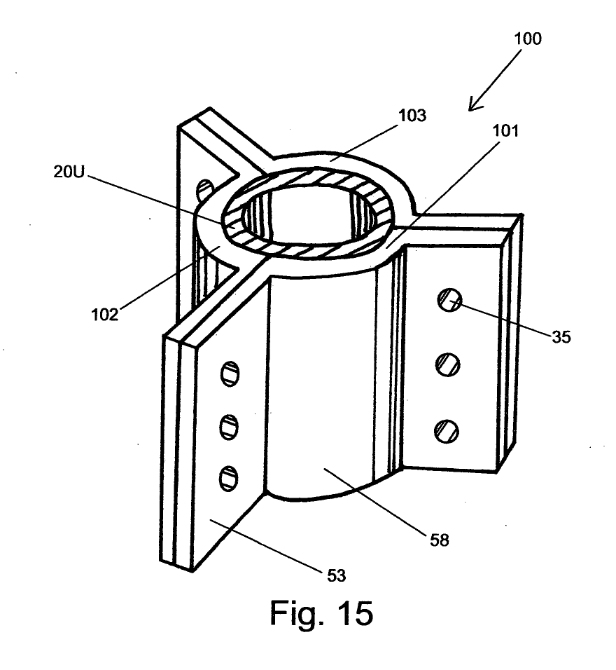

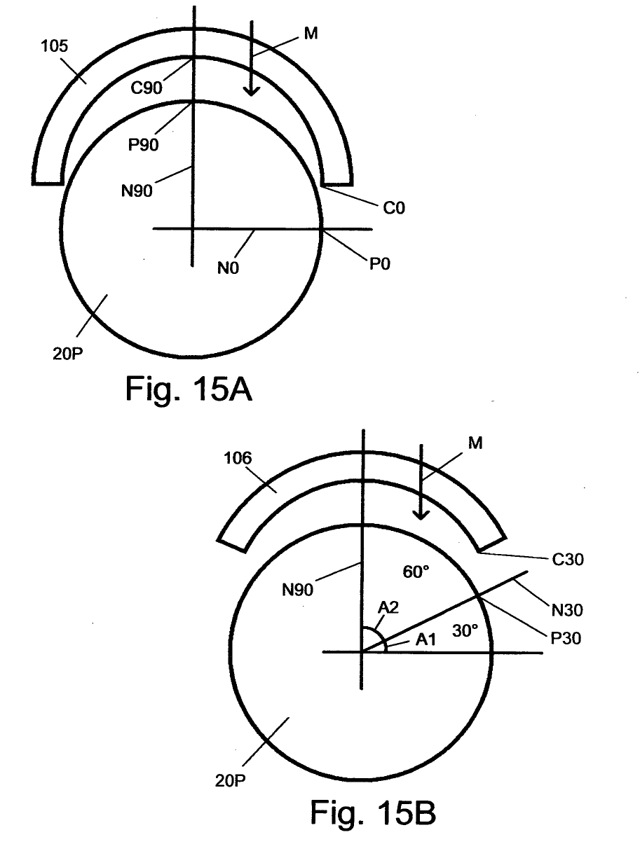

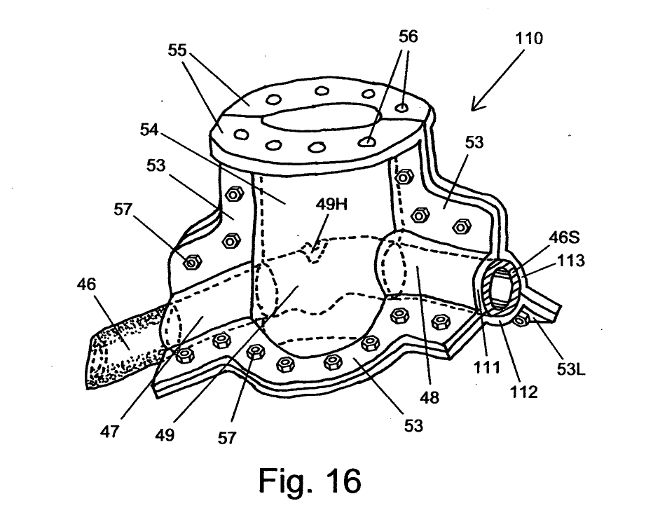

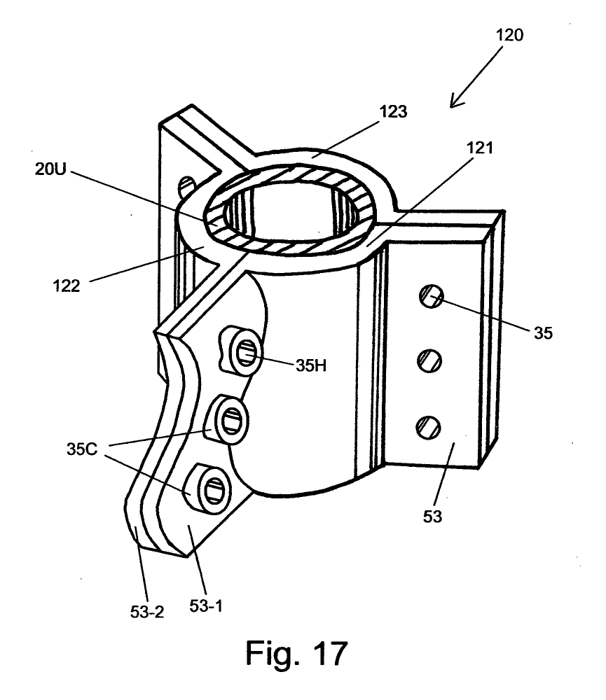

Parts which are groups or aggregates are indicated in the table with the symbol “&”. Some of the parts may have alternate names, or abbreviated names, which are shown here in parentheses.

| ## | Description | Figures |
|---|---|---|
| 20 | broken pipe & | FIGS. 1 3 5 5A 5B 6 6A 9 |
| 20P | pipe-like object | FIGS. 15A 15B |
| 20U | undamaged cylindrical pipe | FIGS. 15 17 |
| 21 | attachment region for broken | FIGS. 1 2 3 9 |
| | pipe | |
| 21M | digital model of attachment | FIG. 3 |
| | region | |
| 22 | broken end of pipe | FIGS. 1 6 6A 9 |
| 23 | end of broken pipe connected | FIG. 1 |
| | to oil source | |
| 25 | laser | FIG. 3 |
| 26 | digital stereo video camera | FIG. 3 |
| 27 | cables and connectors | FIG. 3 |
| 28 | computer graphics work- | FIG. 3 |
| | station | |
| 30 | two piece custom clamp & | FIGS. 4 5 6 6A |
| 31 | clamp 30 plate 1 | FIGS. 4 5 5A 5B 6 6A |
| 32 | clamp 30 plate 2 | FIGS. 4 5 5A 5B 6 6A |
| 33 | matching cavity side 1 | FIG. 4 |
| 34 | matching cavity side 2 | FIG. 4 |
| 35 | holes for bolts | FIGS. 4 15 17 |
| 35C | bolt-collars | FIG. 17 |
| 35H | bolt-collar holes | FIG. 17 |
| 36 | gasket | FIGS. 5A 5B |
| 36M | gasket meeting surface | FIG. 5A |
| 37 | gasket flap area | FIG. 5B |
| 38 | adjusted area of clamp | FIG. 5B |
| 41 | clamp bolts | FIGS. 6 6A |
| 42 | tool platform mounting | FIG. 6A |
| | bracket | |
| 43 | platform attachment bolts | FIG. 6A |
| 44 | machine tool platform | FIG. 6A |
| 45 | milling machine | FIG. 6A |
| 46 | leaking pipe & | FIGS. 7 8 16 |
| 46A | broken pipe A | FIG. 8A |
| 46B | broken pipe B | FIG. 8A |
| 46S | cross-section of leaking pipe | FIG. 16 |
| 47 | attachment region 1 | FIGS. 7 8 8A 16 |
| 48 | attachment region 2 | FIGS. 7 8 8A 16 |
| 49 | intermediate region | FIGS. 7 8 16 |
| 49A | broken end of pipe A | FIG. 8A |
| 49B | broken end of pipe B | FIG. 8A |
| 49H | hole in pipe | FIG. 16 |
| 50 | 2-plate clamp for leaking | FIG. 8 |
| | pipe & | |
| 50J | two-piece joining clamp & | FIG. 8A |
| 51 | clamp 50 plate 1 | FIGS. 8 8A |
| 52 | clamp 50 plate 2 | FIGS. 8 8A |
| 53 | clamshell flange | FIGS. 8 8A 15 16 17 |
| 53-1 | curved flange of plate 121 | FIG. 17 |
| 53-2 | curved flange of plate 122 | FIG. 17 |
| 53L | lower plate flange | FIG. 16 |
| 54 | barrel region | FIGS. 8 8A 16 |
| 55 | adaptor flange | FIGS. 8 16 |
| 56 | adaptor flange holes | FIGS. 8 9 13A 16 |
| 57 | bolts | FIGS. 8 8A 9 13A 13C 14 16 |
| 58 | span of plate | FIG. 15 |
| 60 | two-piece clamp & | FIG. 9 |
| 61 | clamp 60 plate 1 | FIG. 9 |
| 61B | cavity pipe clamp plate 1 | FIG. 10B |
| 62 | clamp 60 plate 2 | FIG. 9 |
| 62B | cavity pipe clamp plate 2 | FIG. 10B |
| 63 | clamp 60 clamshell flange | FIG. 9 |
| 64 | clamp 60 barrel region | FIG. 9 |
| 65 | clamp 60 adaptor flange | FIG. 9 |
| 67 | pipe with severe cavity | FIGS. 10A 10B 10C |
| 68 | cavity | FIGS. 10A 10B 10C |
| 70 | top flange joint of DH BOP & | FIGS. 11 12A 12B 12C 13A 13C |
| 71 | possible connection region 1 | FIGS. 11 12A 12C |
| 71C | clamp portions which seal | FIG. 13B |
| | area 71 | |
| 72 | possible connection region 2 | FIGS. 11 12B 12C |
| 73 | bolt-blocked region (bolt | FIG. 11 |
| | “shadow”) | |
| 74 | BOP cavity region & | FIG. 11 |
| 75 | clamp for region 71 | FIG. 12A |
| 76 | clamp for region 72 | FIG. 12B |
| 78 | clamp for both 71 and 72 | FIGS. 12C 13A 13B |
| 80 | two-piece clamp for 71 and | FIGS. 13A 13B 13C |
| | 72 & | |
| 81 | clamp 80 plate 1 | FIGS. 13A 13B 13C |
| 82 | clamp 80 plate 2 | FIGS. 13A 13B 13C |
| 83 | mating flange | FIGS. 13A 13B 13C |
| 84 | clamp 80 barrel region | FIGS. 13A 13C |
| 85 | clamp 80 adaptor flange | FIGS. 13A 13C |
| 86 | isolated fluid cavity | FIG. 13A |
| 88 | boundary between plates | FIG. 13B |
| 89 | bottom part of clamp 80 | FIG. 13B |
| 89A | support bracket | FIG. 13C |
| 90 | support girders | FIG. 13C |
| 90B | BOP | FIG. 13C |
| 90C | 3-plate clamp for 95 | FIG. 14 |
| 91 | clamp 90C plate 1 | FIG. 14 |
| 92 | clamp 90C plate 2 | FIG. 14 |
| 93 | clamp 90C plate 3 | FIG. 14 |
| 95 | clover-shaped object | FIG. 14 |
| 100 | 3-plate clamp for 20U | FIG. 15 |
| 101 | clamp 100 plate 1 | FIG. 15 |
| 102 | clamp 100 plate 2 | FIG. 15 |
| 103 | clamp 100 plate 3 | FIG. 15 |
| 105 | 180-degree clamp plate | FIG. 15A |
| 106 | 120-degree clamp plate | FIG. 15B |
| 110 | 3-plate containment clamp & | FIG. 16 |
| 111 | clamp 110 plate 1 | FIG. 16 |
| 112 | clamp 110 plate 2 | FIG. 16 |
| 113 | clamp 110 plate 3 | FIG. 16 |
| 120 | curved-flange clamp & | FIG. 17 |
| 121 | clamp 120 plate 1 | FIG. 17 |
| 122 | clamp 120 plate 2 | FIG. 17 |
| 123 | clamp 120 plate 3 | FIG. 17 |
| A1 | angle of N30 with X-axis | FIG. 15B |
| A2 | angle of N30 with Y-axis | FIG. 15B |
| B | laser beam | FIG. 3 |
| C0 | point approaching P0 | FIG. 15A |
| C30 | point approaching P30 | FIG. 15B |
| C90 | point approaching P90 | FIG. 15A |
| K1 | knob 1 | FIG. 14 |
| K2 | knob 2 | FIG. 14 |
| K3 | knob 3 | FIG. 14 |
| L | leaking oil | FIGS. 7 8 11 13C |
| M | clamp motion vector | FIGS. 15A 15B |
| N0 | 0-degree radial line | FIG. 15A |
| N30 | 30-degree radial line | FIG. 15B |
| N90 | 90-degree radial line | FIGS. 15A 15B |
| P0 | 0-degree pipe surface point | FIG. 15A |
| P1 | reference point 1 | FIG. 14 |
| P2 | reference point 2 | FIG. 14 |
| P3 | reference point 3 | FIG. 14 |
| P30 | 30-degree pipe surface point | FIG. 15B |
| P90 | 90-degree pipe surface point | FIG. 15A |

### DETAILED DESCRIPTION—STRUCTURE

### A Broken Pipe

FIG. 1 shows a broken pipe 20 against which we would like to create a tight seal. Notice that the pipe has been bent and distorted from its original round shape. Because of this distortion, a round prior-art clamp cannot be used to fix it; some process of custom-fitting must be used instead. The middle section of this pipe, marked with lines, is a chosen attachment region 21 for this pipe, a region where we want to fasten a custom-fitted clamp. The broken end 22 of the pipe is where oil may be leaking. The connected end 23 of the pipe remains connected to the oil source.

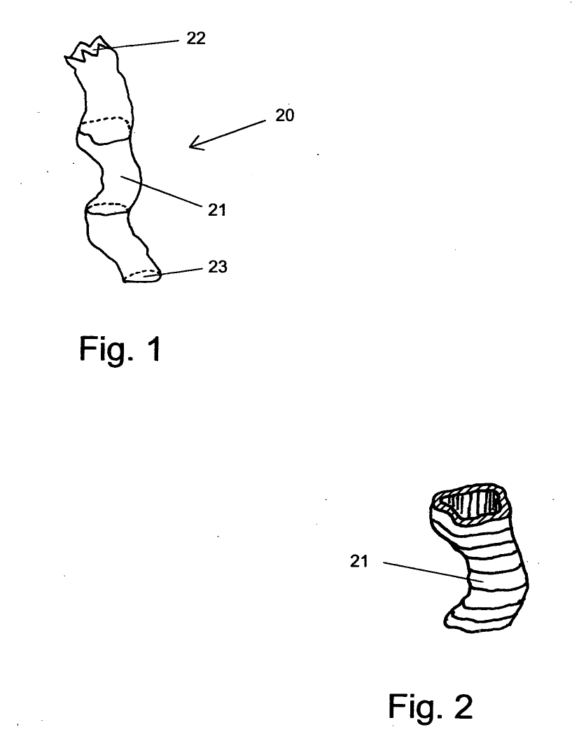

FIG. 2 is a more detailed view of the attachment region 21 seen in FIG. 1. The contour lines give an indication of the shape we need to match in order to create a tight seal on this part of the pipe. At the top of this portion of the pipe, we see a cross-section view. This section is taken through a plane perpendicular to the approximate central axis of the broken pipe 20 shown in FIG. 1. Because the pipe has been distorted from its original cylindrical shape, this axis can only be determined approximately.

### The Pipe is Scanned

FIG. 3 illustrates one of a number of processes that might be used to create a precise geometric model of the attachment region 21. A laser 25 is being used here to illuminate points of the broken pipe 20. The laser beam B is moved in a scanning pattern across the surface we wish to measure. A digital stereo video camera 26 records the light from these illuminated points. Data from the laser and the camera are transferred via cables and connectors 27 to a computer graphics workstation 28 where the data is used to create a 3-dimensional digital mathematical model 21M of the attachment region 21.

In some embodiments, data would be transferred wirelessly, or by the physical transport of a physical recording medium, such as a compact disk or RAM drive.

### A Custom Clamp

In FIG. 4 we see a 2-piece custom clamp 30. This custom-made device has been fabricated using any one of a number of digital manufacturing techniques, based on the digital surface model of the attachment region 21 obtained by the process shown in FIG. 3. This clamp has two sides, called plates, the rear plate 31 and the front plate 32. The two plates each have matching cavities which fit precisely around the attachment region 21 of the broken pipe 20, these being the rear matching cavity 33 and the front matching cavity 34. Just to be clear, these two matching cavities (33 and 34) do not match each other; rather, they match the two sides of the attachment region 21. The plates are also equipped with bolt holes 35 which will allow the clamp to be tightened in place onto the pipe with bolts. The plates are preferentially made of steel, but other materials might also be appropriate in particular applications.

FIG. 5 shows a top view of the custom clamp 30 of FIG. 4 assembled around the attachment region 21 of the broken pipe 20. The pipe is shown in cross-section. This section is taken through the same plane described in our discussion of FIG. 1.

Notice the precise fit of the clamp around the irregularly-shaped pipe. Notice also that the pipe is not round in cross-section, nor are the front and rear matching cavities (34 and 33 respectively) symmetric in shape. The clamp is a true custom-fitted manufactured object, precisely fabricated to fit onto the broken pipe.

In this figure, the precise fit relies on metal-to-metal contact between the clamp and the pipe. In some applications, however, it may be necessary to use gaskets, as shown in the next two figures.

### Gaskets

In FIG. 5A we see a two-piece clamp, for the same region of the broken pipe, which uses a gasket 36. The pipe 20 is shown in a cross-section through the same plane described in our discussion of FIG. 1.

Gaskets can be made from rubber, plastic, or other materials. Such materials would require adequate strength and elasticity, as well as an ability to withstand temperature changes, and to be resistant to decay or decomposition in the installation environment.

The gasket 36 is sandwiched between the surface of the broken pipe 20 and the inner surfaces of the front plate 32 and the rear plate 31 of the clamp. The gasket meeting surface 36M is a thin strip of surface where the two sides of the gasket meet.

When a gasket is used, the plates themselves, when they are manufactured, must be shaped so as to allow extra room for the gasket. We will explain how this can be done in more detail in the operational discussion below. In FIG. 5A, the gasket shown seals only the contact between the plates and the pipe. However, it may also be necessary to use gaskets which seal the contact between portions of the plates themselves, as shown in the next figure.

FIG. 5B illustrates another form of gasket. As in FIG. 5A, we see the front plate 32, the rear plate 31, the broken pipe 20 in cross section, and the gasket itself 36. This gasket, however, extends beyond the boundary between the pipe and the plates, including a portion of the boundary between the two plates themselves. This region is called the gasket flap area 37. Note that, in this version, the clamp plates are fabricated so that they bulge slightly, in order to accommodate the gasket flap, while maintaining an adequate thickness for the clamp plates. These bulges are called gasket extension plate adjustments 38. Based on engineering considerations, the gasket flaps, and the plate adjustments, might actually extend over the entire matching surfaces of the plates in some installations. In this example, however, the gasket flaps are smaller than that, their width being only about twice the thickness of the pipe.

Here again, as in the previous two figures, the pipe 20 is shown in a cross-section through the same plane described in our discussion of FIG. 1.

### An Attached Clamp

FIG. 6 shows the two-piece clamp 30, first seen in FIG. 4, now placed around the broken pipe 20. The front plate 32 and the rear plate 31 are fastened together with nuts and bolts 41. Because the plates are custom manufactured to fit the pipe, such fastening produces a tight, mechanically rigid joint between the pipe and the two-piece clamp. This particular clamp is very simple, and is presented here primarily as an initial example of how the custom-clamping process works. By itself, the clamp shown here does not allow for the sealing of the leak at the broken end 22 of the pipe; we will see how to do that later on.

### A Tooling Platform

FIG. 6A shows a two-piece clamp 30 similar to the one in FIG. 6, but with a longer “flap” on the left. This flap is a tool platform mounting bracket 42. It is used to attach a machine tool platform 44 to the clamp 30, by means of platform attachment bolts 43. This platform then has a rigid mechanical connection to the pipe 20, making the platform a suitable location to mount a machine tool such as a milling machine 45, so that the milling machine can make precise, reliable cuts in the material of the pipe, in particular at the broken end 22. This shows that custom-shaped clamps can play an important role in building the solid machine-tool platforms which may be needed in an oil spill, or other situation where pipes or other structures have been damaged. We will have more to say later on about the importance of solid machine-tool platforms.

### A Damaged Pipe

FIG. 7 shows a leaking pipe 46. This pipe has been damaged, but it is not fully severed by a break. (A portion of the riser pipe near the BOP at the Deepwater Horizon oil well had a leak of this kind.) Leaking oil L is being discharged from the damaged area of the pipe. Regions 47, 48, and 49 of the pipe, bounded by dotted lines in the figure, are sections which will be scanned in order to create a clamp which will contain the leaking area of this pipe.

### Oil Containment Clamps

In FIG. 8, we see our first example of custom-manufactured oil-containment clamp. The two-piece containment clamp 50, has a front plate 52, and a rear plate 51, much like the more simple clamps shown in FIGS. 4, 5, and 6. However, it has a number of additional structures and features, as follows. In previous figures, the clamps were attached to the broken pipe 20 at only a single section, that section being the attachment region 21. In FIG. 8, however, the clamp attaches at two different attachment regions, 47 and 48, separated by the intermediate pipe region 49. This separation allows the plates of the clamp to surround the leaking area of the pipe.

Like previous clamps, the current clamp has flaps or flanges 53 which, when fastened with bolts 57, hold the two plates together. Each of the two plates also includes a roughly half-cylindrical cavity. These two cavities, when combined, create a barrel-shaped region 54, which encloses the damaged portion of the pipe. At the top of each plate, the flanges 53 turn at a 90-degree angle, and become adaptor flanges 55. These two flanges combine to form a standard round flange onto which a standard (non-custom) plumbing connector can be bolted, using the adaptor flange holes 56.

The net effect of these features is that the clamp 50 functions as a kind of transitional plumbing adaptor. At one end of this transitional adaptor is a device, composed of the clamp surfaces which mate with parts 47 and 48 of the leaking pipe. This device can be (and here is) firmly sealed onto that pipe. At the other end of the adaptor is a standard plumbing flange composed out of the two adaptor flange parts 55. This allows for the leak to be sealed. The leaking oil L now has only one way to get out of the enclosed barrel region 54, and once a standard plumbing flange (fastened to a riser pipe or other extraction plumbing) is attached to the top of the clamp, this oil can be contained or captured. Although region 49 of the pipe is not in direct contact with the clamp, it must also be scanned (in the context of certain scanning methods) so that its geometry can be digitally modeled. The reason for this is that the geometry of region 49 provides information about the relative position and orientation of regions 47 and 48, and this information is essential in designing the shape of the clamp. We will have more to say about this later on in the function and operation discussion.

### A Joining Clamp

Containment clamps can also be used to join together two or more broken pieces of irregular pipe. In FIG. 8A, we see just such a clamp 50J, called a joining clamp. It is being used to fasten together two pipes 46A and 46B in a fluid-tight way, just as one might do with undamaged pipes using welded or screwed-on flanges. The broken ends 49A and 49B of the two pipes are enclosed within the sealed-off region 54 surrounded by the clamp.

The other features shown in FIG. 8A are analogous to those of FIG. 8.

### Another Containment Clamp

FIG. 9 shows our second example of a custom-manufactured oil-containment clamp, this being the two-piece containment clamp 60, designed to help in capping the leak on the broken pipe 20 which we have seen previously. In FIGS. 4, 5, and 6, we saw how to attach a simple custom-made clamp onto the chosen attachment region 21 of the pipe. In the current figure, we have attached a clamp of a more complex design to this same region. This clamp has a front plate 62 and a rear plate 61, combined around the attachment region 21 of the broken pipe, and fastened together with bolts 57 which pass through mating flanges 63. The broken end 22 of the pipe 20 is surrounded by a barrel-shaped region 64 formed within the clamp.

In similar fashion as with the clamp of FIG. 8, these mating flanges turn at a 90-degree angle at the top of the clamp, and form a pair of adaptor flanges 65, which join to form a standard round flange that can be used to attach a standard (non-custom) matching plumbing fixture by means of bolts passed through the adaptor flange holes 56, allowing the leak from the broken end 22 of the pipe to be contained and/or extracted.

In the pipe of FIG. 8, the leak was in the middle of the pipe, and as a result, the clamp for that pipe required two attachment sites. In FIG. 9, however, since the leak is at the broken end 22 of the pipe, a single attachment site 21 is sufficient. Like the clamp of FIG. 8, the clamp shown here in FIG. 9 functions as a kind of specialized plumbing adaptor that has a standard flange surface, composed of the two adaptor flanges 65, at one end, and a custom-made surface, matching the attachment region 21 of the broken pipe, at the other end. The result is to allow a standard plumbing fixture to be attached, via the adaptor, to the broken pipe 20.

### Severe Cavities

If a pipe has certain kinds of severe distortions, it may not be possible to make a fluid-tight clamp of the kind we have been discussing. FIG. 10A shows a cross-section view of such a pipe 67. The cross-section is taken through a plane perpendicular to the approximate cylindrical axis of the pipe. (As with the broken pipe 20 in FIG. 1, this axis can only be determined approximately.)

The pipe has a cavity 68 in its wall which has a narrow opening and a space inside that is larger than this opening. A cavity of this kind might make it difficult or impossible to slide a two-piece clamp into place so that it makes contact with the entire surface of the pipe.

FIG. 10B shows a two-piece clamp, composed of plates 61B and 62B, which could be fastened around the pipe 67, without creating a seal in the surface of the cavity 68. A clamp of this kind would be successful in creating mechanical rigidity to support a tool platform similar to the one in FIG. 6A, but it would not be successful in creating a fluid-tight seal against leaks.

FIG. 10C shows another view of the pipe 67 and the cavity 68. This view makes it evident that a containment clamp of the kind shown in FIG. 9 would fail if it was based on a clamp similar to that shown in FIG. 10B. The channel created by the cavity 68 would allow oil to leak out of the containment region within the clamp.

### The Top Joint of a BOP

FIG. 11 shows the top flange joint 70 of a BOP, in a state similar to that of the Deepwater Horizon BOP after the riser pipe was sheared off just above the BOP. Leaking oil L is coming out the top of the joint, through the remains of the riser pipe. As we have seen, only certain kinds of regions have the geometry required to become an attachment site for one of our custom-made containment clamps. One possible site on the top flange joint is the cut-off riser surface 71. This surface is the outside of the remains of the riser, possibly together with the upper part of the upper pipe flange itself.

Another site is the flange edge surface 72. This is the cylindrical edge of the joint where the two flange surfaces are held together. Region 73 may not be suitable because the presence of the bolts would create problems in moving a plate of the clamp into position. Region 74, indicated by the oval outline, is definitely not a suitable attachment site, because it has cavities of the kind examined in FIGS. 10A-10C.

### Attachment Sites for Consideration

FIG. 12A shows a side view of the top flange joint 70 of a BOP, as in FIG. 11. Shown in cross-section is a possible shape 75 for a sealing clamp which would attach to the flange assembly on the cut-off riser surface 71. The cross section here taken through a plane containing the central cylindrical axis of the flange joint.

In FIG. 12B, we see the same side view of the top flange joint 70 of a BOP as in the previous figure. Here, the cross-section, also through a plane containing the central cylindrical axis of the flange joint, shows a possible shape 76 for a sealing clamp which would attach to the flange assembly on the flange edge surface 72.

In FIG. 12C shows a cross section view of a possible shape 78 for a sealing clamp which uses both of the attachment surfaces 71 and 72. Attaching to the top flange joint 70 in this way has the advantage of greater sealing surface area compared to the clamps shown in FIGS. 12A and 12B. The use of two attachment sites also makes the attachment of the clamp more mechanically rigid. As before, the cross-section is through a plane containing the central axis of the flange joint.

### A Clamp for the Top Joint

FIG. 13A shows a two-piece containment clamp 80 based on the attachment strategy illustrated in FIG. 12C. The clamp has a rear plate 81 and a front plate 82. These fit together in the same manner as the other clamps we have seen, using mating flanges 83, fastened together with bolts 57.

The barrel-shaped region 84 has an adaptor flange, made from two parts 85, with bolt holes 56. Parts of plates 81 and 82, at the bottom and front of the figure, have been cut away to provide a more detailed view of how the clamp attaches onto the BOP flange joint. In this cut-away area, the two pieces 78 envisioned in FIG. 12C are shown in a cross-section through a plane containing the central axis of the BOP flange joint assembly 70, this plane making a dihedral angel of roughly 60° with the plane where the mating flanges of the clamp meet.

This clamp can be seen as a somewhat more complex version of the clamp shown in FIG. 9. In that earlier clamp, the attachment region 21 was covered in a single contact region, that region having the topology of a cylindrical surface. Here, as we've seen, we can't seal against the “bolt-shadowed” region 73, so we have to settle for an attachment region that is made up of two disconnected sealing surface regions. Between these two regions is a sealed, isolated fluid cavity 86.

It is worth noting that the barrel 84 could be made substantially shorter here than shown, because, unlike in the clamp of FIG. 9, the target object to be sealed does not protrude upward very far from the attachment site.

The flange joint assembly 70 obscures much of the inside surface of the bottom portion of the clamps. We will take a closer look at it in the next figure.

FIG. 13B shows a closer view of the bottle-within-a-bottle shape of the lower part of the containment clamp 80 seen in FIG. 13A. As in FIG. 13A, we see the rear plate 81 and the front plate 82 of the clamp, as well as the mating flanges 83. In this figure, the top and front portions of the clamp have been cut away, revealing cross-sections of the clamp. Contour lines in FIG. 13B give a sense of the shape of the clamp. The heavy line 88 shows where the two plates of the clamp meet. This figure gives us a clearer view of the region 89, a part of the clamp which, in FIG. 13A, was largely hidden by the flange joint assembly 70.

The clamp, with the mating flange 83 removed, would almost look like a solid of rotation, obtained by rotating the shapes 78 about the central axis of the flange joint assembly 70. (That assembly isn't shown in this figure, but you can see where it goes by comparing the current figure to FIG. 13A.) However, the resemblance of the clamp to a solid of rotation is only approximate, because the riser pipe remnant 71 (also not shown here) has been damaged and may no longer be precisely round. Thus the portions 71C of the clamp which fit against it may also not be precisely round.

The cross section seen in the surfaces 78 is taken through the same sectional plane described in FIG. 13A. The cross-section at the top, seen in surface portions 87, is taken through a plane perpendicular to the central axis of the BOP flange joint assembly 70, this plane being at approximately the same height as the ragged cut-away boundary seen in FIG. 13A.

### The Clamp in Place on the BOP

FIG. 13C is a perspective view of a two-piece clamp 80 similar to that shown in Figs 13A and 13B, installed on top of a BOP 90B. Because of the small surface area of contact at the two attachment areas (71 and 72 in FIG. 12C), this clamp may need to have mechanical supports 90 to help stay it in place without putting excess strain on the attachment areas. The supports are attached to the clamp using brackets 89A. Both the supports and the brackets are shown in simplified form in the figure. Like previous views of this type of clamp, the clamp shown has a rear plate 81, and a front plate 82, held together by bolts 57 which pass through mating flanges 83. The clamp encloses a barrel-shaped region 84, at the top of which is a standard adaptor flange 85 for the attachment of a riser pipe or other containment/extraction plumbing. Inside the clamp, shown in dotted lines, is the top flange joint 70 of the BOP. Leaking oil L is also shown in dotted lines as it exits the top flange joint.

### A Shape Requiring a 3-Plate Clamp

Not all shapes can be matched with a two-plate clamp. FIG. 14 shows a shape of this kind, surrounded by a 3-plate clamp, shown in cross-section. This shape could be defined by a pipe, but for simplicity here we have not drawn such a pipe. The 3-part clamp 90C is composed of 3 plates, labeled 91, 92, and 93, held together with bolts 57. The object itself is a cylindrical solid whose cross-section is the clover-shaped region 95 seen within the clamps. The plane of the cross-section shown is perpendicular to the axis of that cylinder.

An intuitive geometric argument can be used to establish that the object shown cannot be matched with any two-piece clamp which is moved into place along a direction not parallel to the object's surface. While this argument is not a fully rigorous mathematical proof, it is helpful in understanding why multi-piece clamps may be needed in some cases.

For simplicity, we will consider, for the purpose of this geometrical argument, only those clamps whose plates meet in planes passing through the axis of symmetry of the clover-shaped cylindrical object shown. Such clamps will be called axial clamps. (See FIG. 15 for a simple example of an axial clamp.) Suppose we have an axial clamp C that wraps around the object. The 3-plate clamp shown in the figure is one such clamp, but here we are considering an arbitrary clamp which might conceivably have only two plates.

Let Q be one of the points P1, P2, and P3. Denote by T(Q) the plate of the clamp C which touches the object at the point Q. Because C is an axial clamp, the plate T(Q) will remain in contact with the object along the entire extent of a vertical line parallel to the axis of the object and lying on the surface of the object. (In effect, what we are saying here is that axial clamps go straight up and down the cylindrical object, rather than, for example, winding around it in a helical manner.)

Suppose we can show that the plates T(P1), T(P2), and T(P3) are all different. Since we have three distinct points, this would mean that there must also be three distinct plates. In other words, it would show that C cannot consist of only two plates. Thus, all we need to do is show that no two of these three points are covered by the same plate of the clamp.

Since the points are symmetric, we can consider any two of them, say P1 and P2. However, it is pretty clear that P1 and P2 cannot be covered by the same connected plate. How is this plate going to get from P1 to P2? To do that, the plate must either go clockwise or counter-clockwise around the object. If it goes clockwise, it will have to wrap around the knob-like portion K3 of the object. If it goes counter-clockwise, it will have to wrap around both of the two similar knobs K1 and K2, also, therefore, touching point P3 along the way. Either way, we will have a plate wrapping all the way around one of these knobs, from one of the reference points (these being P1, P2, and P3) to the next. Let's say this knob is K3, for example. The problem with this is that it would not be possible to install such a plate on the object. It could not be moved into place against the object in a practical way.

The reason for this is that the gap between points P1 and P2 is too narrow to get past the knob K3. Bearing in mind that the clamp C is axial, the plate will be in contact all the way up and down the cylinder as it wraps around K3. This means it cannot be twisted off, nor could it have been twisted into place. Because of the way it is wrapped around K3, the only possible motion for such a plate would be to slide it in a direction parallel to the axis of the cylinder.

But we are assuming for the purpose of this argument that plates will not be installed in that way. In fact, parallel sliding of that kind isn't a practical method for installing plates, since it could be used only in very special cases, and it would also be prone to jamming. (It is worth noting that, if parallel motion is allowed, the object shown here could in principle be matched with a 1-piece device that would be slid onto it in a telescoping manner, along the axis of the cylinder.)

Based on the argument presented here, we see that an object of this type, for practical purposes, requires a 3-plate clamp of the kind shown in the figure. Such clamps have significant advantages which we will discuss further in a later section.

### Example of a 3-Plate Clamp

In FIG. 15 we see an example of a 3-plate clamp 100, shown in perspective view. For simplicity this example shows a clamp that fits onto an undamaged cylindrical pipe 20U. The clamp 100 has 3 plates, plate 101, plate 102, and plate 103. Each plate has two flanges 53, with holes 35. The portion of each plate connecting the two flanges is called the span, indicated here as item 58. The end of the pipe 20U is shown in cross-section here, through a plane normal to the cylindrical axis of the pipe. Bolts are not shown in this figure.

### Three-Plate Clamps Reduce the Risk of Jamming

Three-plate clamps are less likely to jam when installed than are 2-plate clamps. The reason for this is illustrated in FIGS. 15A and 15B. Since the concepts involved can be understood abstractly in terms of plane geometry, they will be presented using simplified schematic objects in the two figures. FIG. 15A shows an object 105 which is like a single plate of a 2-plate clamp. This object is being lowered along direction M onto a round, pipe-like object 20P. Points P0 and P90 are on the surface of the pipe at angles of 0° and 90° respectively, measured counterclockwise from the positive horizontal axis. Lines N0 and N90 are the lines normal to the pipe through these two respective points, while C0 and C90 are the points on the inner surface of the clamp which are approaching those two respective points as the clamp plate 105 is moved into place. (The lines NO and N90 can also be described as radial lines in relation to the pipe-shaped object 20P.)

There is a dramatic difference between the way C90 approaches P90, and the way C0 approaches P0. The point C90 approaches the pipe head on, with its direction of motion M parallel to the normal. At P90, this direction of motion makes an angle of 0° with the surface normal, and hence an angle of 90° with the surface tangent line. (The tangent line is not shown in the diagram.) This head-on approach reduces the lateral movement of the approaching point to a minimum Thus, the odds of scraping and jamming are also minimized.

In stark contrast, consider the movement of the point C0 as it approaches its target surface point P0 along the same direction of motion M. Now the motion is edge-on, rather than head-on. The direction of motion of C0 makes an angle of 90° with the surface normal, and an angle of 0° with the surface tangent line. This movement of C0 is, in a precise sense, totally lateral in relation to the surface, at the moment when C0 reaches P0. This means that the odds of scraping and jamming will be greater here than at anywhere else on the approaching plate.

The region on the pipe near point P0 is called the tangential installation region. It is an area where the installation process is very sensitive to slight variations in the pipe's surface. Rather small differences in the shape of the manufactured plates, differences found in those areas of the clamp meant to match this region, can potentially influence whether or not it is geometrically possible to install the clamp at all.

In FIG. 15B, however, the situation is significantly different. Now the approaching plate 106 is similar to a single plate of a 3-plate clamp. While plate 105 is designed to span 180° of the pipe's surface, plate 106 is designed to cover a span of only 120°, that span being, in this orientation, 60° to either side of the vertical axis.

As the plate 106 moves toward the pipe, the rightmost point C30 on the inner surface of the plate is approaching a point P30 on the surface of the pipe. One can see that the lateral movement here is significant, but not as severe as the fully-tangential movement of CO in the previous figure. Here, the angle between the direction of motion M and the surface normal line N30 is only 60°. To see this, note that M is parallel to the vertical axis N90, thus M will form an angle with N30 equal to that formed by N90 and N30. But this latter angle is evidently 60°. This means that the angle between M and the tangent line at P30 will be 30°. The component of lateral movement can be thought of as the projection of M onto this tangent line. If we think of M as a unit vector, the magnitude of this component will simply be cos(30°), just over 0.866. This is appreciable lateral movement, but less than the magnitude 1.0 lateral movement component for the point C0.

We therefore see that, while scraping may be somewhat of a problem as point C30 approaches the pipe, it is still significantly better than the scraping risk at the point C0. The conclusion is that 3-plate clamps, when being installed, are less likely to jam than 2-plate clamps.

Clamps with 4 or More Plates

If you have a clamp with n plates, the angle analogous to A2 in FIG. 15B works out to be 360/2n, and so the angle analogous to A1 would be 90-360/2n. As n increases, this angle gets larger, approaching 90° as n approaches infinity, this being the equal to the very favorable angle we saw for the point C90 in FIG. 15A. One can express this limit geometrically by observing that tiny plates will approach the surface in a near head-on manner.

This means that the more plates you have, the more favorable the angles will be, in terms of reducing the odds of jamming. So, for example, with 4 plates (n=4) the angle between M and the tangent line at the edge of the plate will be 90-360/8=45°, so the projection of M onto the tangent line will have magnitude)cos(45°), just over 0.707, somewhat better than the 0.866 we got with 3 clamps. However, of course, having too many plates will bring problems of its own.

We are guessing that 3 plates is probably close to optimal in the sense that a 3-plate clamp gets you significant reduction in the odds of jamming, without bringing in so many plates that other issues begin to be a concern. Some of the problems a many-plate clamp might have are manufacturing time, assembly time, bolt-clearances, and mechanical strength. Also, the increased gasket-join length would mean more places where gaskets might fail. The result could be that gasket tolerances, quantifying the odds of gasket breakdown, might be exceeded if the plate count gets too large.

A 3-Plate Containment Clamp

For each of the 2-plate clamps we have seen, an equivalent 3-plate clamp can be constructed. For example, FIG. 16 is a perspective view of a 3-plate clamp 110 designed to fit on the same leaking pipe as the 2-plate clamp of FIG. 8. The leaking pipe 46 is now surrounded by 3 plates, each covering an angular span around the pipe of about 120°. At the right end of the assembly, we see a configuration of parts similar to those visible at the top of the 3-plate clamp shown in FIG. 15. In order to make these parts easier to see, the right-most portion of the pipe 46 has been cut away, creating a cross-section surface 46S. This cross-section is made through a particular plane perpendicular to the approximate cylindrical axis of the pipe 46, this being the same plane where the attachment region 48 ends, or, to put it another way, the plane where the designer of this 3-part clamp chose to terminate the three plates.

Wrapped around this pipe, sealed against the attachment region 48, we see the three plates 111, 112, and 113 of the clamp 110. A small portion of the flange 53L of the lower clamp 112 is visible to the lower right of the cross-section 46S. One bolt, partially visible, can also be seen there.

At the left end of the pipe, the three plates enclose attachment region 47 in a similar manner. Each plate has flanges 53 which are bolted together as with a 2-plate clamp.

FIG. 16 also shows the hole 49H in the leaking pipe. The other features in FIG. 16 are analogous to those seen in FIG. 8, where the 2-plate clamp for this same pipe is shown. Leaking oil, however, visible in FIG. 8, is not shown in FIG. 16.

A Clamp with Curved Flanges

The flanges on the clamps of the present invention do not need to be flat. In fact, curved flanges have a particular advantage which we will examine in a later section. FIG. 17 shows a 3-piece clamp similar to the one shown in FIG. 15. In this clamp, however, two of the 6 flange surfaces are curved. The clamp 120 consists of three plates 121, 122, and 123. While plate 123 has the same shape here as plate 103 in FIG. 15, plates 121 and 122 now each have a curved flange. Flanges 53-1 and 53-2 are the curved flanges on plates 121 and 122, respectively.

These two curved flanges fit together when the clamp is assembled, as seen in the figure. Each of the two curved flanges is equipped with 3 bolt-collars 35C. Each bolt-collar is a cylindrical body of material with a coaxial cylindrical hole 35H. One can visualize the bolt-collars as being like towers which rise up out of a non-flat landscape, that landscape being the surface of the curved flange.

The three bolt-collars visible here are those integrated into flange 53-1. The mating flange 53-2 has three matching bolt-collars, but they are not visible in this figure. Each of the 3 bolt collars on flange 53-2 is opposite to one of the three bolt collars on flange 53-1, and shares a cylindrical axis with that bolt collar.

In order to fasten the clamp, bolts will be passed through the holes 35H in the bolt-collars (much they are passed through the holes 35 in a flat flange 53) and nuts will be attached. The bolts used for this may have to be somewhat longer than those used to fasten a flat flange 53, because of the extra length contributed by the bolt-collars.

As in FIG. 15, the pipe shown is an undamaged cylindrical pipe 20U, the end of which is shown in cross-section through a plane normal to the cylindrical axis of the pipe.

### DETAILED DESCRIPTION—FUNCTION AND OPERATION

### Introduction

If you want to tightly seal a pipe onto an object, you need something like a pipe flange. But what do you do when an object has no flange, and, worse, has an irregular shape? A mile down in the waters of the Gulf of Mexico, during the summer of 2010, the response to the Deepwater Horizon Oil spill was faced with bent, twisted pipes, some of them with other objects or fittings attached. How can you grab onto an object of that kind with the same rigidity you would get by bolting together two perfectly shaped plates, or pipe flanges, complete with matching holes?

### Custom-Built Clamps Allow for Rigid Seals on Irregular Objects

Suppose you want to seal a pipe onto an irregular object. In order to do this, what we propose, in the present invention, is to make a custom-designed clamp that fits together over some part of the object in a clamshell type of grip. This clamp has two or more portions, called plates, equipped with flanges allowing the plates to be bolted together.

These clamps are constructed so that the shape they enclose almost exactly matches the irregular shape of the object we want to attach to and seal. This match will be of sufficient precision that, once attached, the clamps will provide a fluid-tight seal that is just as good as that of a standard bolted-flange plumbing fixture.

Such clamps can be built using modern techniques of digital object-modeling and computer-controlled machining. We will examine this process in detail below. Once the clamps are built, however, it is a relatively simple matter for undersea ROVs to position them around the target region of the object, and attach them together with nuts and bolts.

### An Illustrated Example

A simple example will show how a clamp can be manufactured which creates a tight, precise-fitting mechanical seal around an irregular pipe. Such clamps can be extended into connectors equipped with standard pipe flanges, or they can be used to attach tooling platforms in order to allow for precise, reliable cuts of damaged pipes.

### The Damaged Pipe

In FIG. 1, we see an irregular, damaged pipe 20. Suppose that, after examining this pipe and considering our options, we decide to build a clamp which will attach onto the pipe in the attachment region 21, located in the central part of the pipe.

A more detailed view of this part of the pipe is seen in FIG. 2. At the top of the object a cross-section is shown, revealing the irregular, asymmetric shape of the pipe in greater detail. The first step in building our clamp is to make a model of this region so that we know its precise shape. In the days before modern digital electronics, such models were created by making casts, using plaster or similar materials. The use of physical casts is still an option, but in today's world, there are faster, more versatile ways to capture the geometric details of a physical object.

### Scanning the Pipe

FIG. 3 shows a laser being used to digitally scan the pipe, in order to build a mathematical data base describing its shape. Other methods, such as high-frequency sonar, stereo optics, or scans using x-rays or gamma rays may also be needed to accomplish this step, in conjunction with computer analysis of the data obtained. [D] It is worth noting here that some kind of precise digital electronic positioning system may also be needed in the ROVs in order to do the scans properly. It may be that the U.S. Navy has such positioning systems, or the means to develop them for an application of this kind.

On land, precise digital scans of 3D objects are a well-established technology. For example, such methods are routinely used in the movie industry to make digital models of people or objects. These models, or traditional physical casting, can then be used to make masks, or other special effects materials that will fit precisely onto the modeled surface.

In FIG. 3, we have imagined that the attachment region 21 is chosen in advance and then scanned. In practice, however, it would be preferable to scan a larger region of the pipe, and then, based on examination of the data obtained, to choose the region 21 to which we want to attach.

### Custom Manufacture of the Clamp

Once we have a precise digital representation of the shape of this section of pipe, we then design and build, using standard digital metalworking techniques [M], two plates which form a two-sided clamp, preferentially made out of steel. Such a custom clamp 30 is shown in FIG. 4. Its plates can be bolted together with matching holes 35. When joined, the two pieces form a cavity which is almost exactly the size and shape of the laser-scanned region of our pipe.

### Remote Underwater Assembly

Using ROVs, we then assemble the two pieces around the pipe, and bolt them together. FIG. 6 shows the result. In order to make the assembly easier, the pieces may have ROV-friendly handles built-in or attached. For simplicity we have not shown these handles in the illustrations.

Once the clamp is in place, and the bolts are tightened, this creates a rigid mechanical connection between the clamp and the pipe. The clamp shown in FIG. 6 is a very simple one which demonstrates how the basic custom-fitting and attachment process works. Later on, we will see how this basic idea can be extended in order to form fluid-tight connections between damaged pipes and conventional undamaged plumbing fixtures.

### Tooling Platforms

On around Jun. 2, 2010, the BP emergency response team cut off the broken riser pipe on top of the Deepwater Horizon BOP. Their plan was to use a remotely-operated underwater diamond saw to get a flat, clean cut on the remains of this riser. Their hope was that this flat surface would allow them to get a tight seal with their planned top hat cap. The diamond saw jammed, and the clean cut was not obtained. A more inexact cut, using huge pair of hydraulic shears, was the best they could do. This failure to get a clean cut was a very serious matter. The top hat cap would be in place for another 6 weeks, and because the cap's seal with the riser stub was not tight, an estimated, 50,000 barrels of oil or more per day flowed into the gulf rather than being captured by the cap. The conclusion is that accurate cuts on damaged pipes are a very serious matter. A lot is riding on whether such precise cuts can be made.

The clamps described in the present invention, even those of the very simple form shown in FIG. 6, will allow us to create rigid tooling platforms in order to make reliable, precise cuts on irregularly-shaped pipes.

### Rigid Platform Control is Essential to Precise Machining

Suppose you want to make a precise cut in a metal object. As every machinist knows, the first thing you would have to do would be to figure out a way to rigidly attach that object to a platform of some kind, a platform that is also rigidly attached to the cutting tool you are going to use. The simplest application of this principle is when you hold a piece of material down on the steel bed of a drill press, while drilling a hole in it. Much the same thing happens when you place a block of material in the chuck of a lathe or a milling machine.

### Irregular Objects are Hard to Hold

The perfect object to machine-cut is a rectangular block of metal with threaded holes already drilled into it. You can easily hold it in a chuck or a vise, or bolt it onto a tool bed of one kind or another. But what do you do when an object has an irregular shape? In FIG. 6A, we see a custom-shaped clamp similar to that shown in FIG. 6, attached to our irregularly shaped pipe 20. This clamp, however, has been bolted onto a machine tool platform 44 supporting a milling machine 45. This arrangement achieves the rigid platform control required for good machining results. Thus, we can now make precise cuts at various places in the broken pipe 20, such as its broken end 22.

As it happens, the simple clamp shown in FIG. 6A may not be the optimal mounting for a milling machine. A better alternative might be to build a clamp which would allow the tools to be mounted in a more central position, nearer to the plane surface where the two plates of the clamp join, instead of off to one side as shown here. It is clear, however, how such a clamp could be created, and how it could be attached to the platform 44.

### Advantages of Milling Machines Compared to Saws

Do remote-controlled deep-water milling machines exist? Maybe not, but after the Gulf oil spill, now that we know what we may have to deal with when a deep-water oil well blows out, such milling machines are an important resource to develop. [T]

As we mentioned in our discussion of the prior art, milling bits are preferable to saw blades in spill-control for several reasons. First, a milling bit is less likely to jam in use than a saw blade, because a milling bit has the ability to cut sideways, as well as forwards, into the material being worked. Also, because of this same multi-directional cutting geometry, a milling bit is less sensitive to movement-control errors than a saw blade. If a milling bit is accidentally canted slightly, or enters the work at an angle, it can still cut its way through the material. In contrast, as soon as a saw blade gets out of the alignment that maintains the pressure between its cutting edges and the work, it may lose its ability to continue cutting, and end up in a situation where its substantial non-cutting surfaces are subject to pressure by the material being worked.

This forgiving response to imprecise movement control is important when ROVs are being used. Of course, we have recommended the use of a firmly attached milling platform, but even there, because tools are being used by remote control, with its less-direct visual input, a tool that is tolerant to movement errors is a significant advantage.

Further, even if they do jam, milling bits are easier to extricate than saw blades, since the cutting surfaces of a milling bit, these being the same surfaces which would get stuck if the bit was jammed, are concentrated in a more compact space, compared to the cutting surfaces of a saw blade. Moreover, when trying to un-jam a saw blade, it is hard to control the movements of a particular part of the blade, especially if work is mediated through ROVs. A milling bit, on the other hand, is not only small but also rigid, compared to a saw blade. And it is easily controlled by its “handle” or shaft. It can be grasped and pulled, it can be twisted or levered in various directions, and all this can be done in a way that is easy to control via an ROV. Saw blades, especially once they jam, just aren't subject to this kind of direct, single-point-of-access movement control.

Another advantage, in recovering from jamming, comes from the finer positional capabilities of the milling machine itself, as compared to a saw. Suppose a milling bit jams in the work material. It might then be possible to simply detach the stuck bit from the chuck of the milling machine, put in a new bit, and then use that new bit to continue cutting away material, eventually freeing the jammed bit. Saws don't have this kind of precision in what portions of the material are to be removed. Moreover, putting in a new saw blade is not likely to be as ROV-friendly as putting a new bit into the chuck of a milling machine.

Finally, the sheer accuracy of the surfaces that can be formed by a rigidly-attached milling device is clearly going to exceed what you can generally get with a saw. Since the goal of the cut is to get a precise flat surface, milling machines come out ahead here as well.

We have already alluded to the crucial significance of clean pipe cuts in oil containment. The failure of the top hat to seal properly was, according to a number of statements by BP, a direct result of the non-flat cut they had to settle for on the riser pipe. Six weeks of oil release were the result of this failure to get a clean cut. For this reason, we believe that the use of milling machines to make underwater cuts on leaking oil pipes represents a significant advance over the prior art. Cutting by milling machine is therefore included as one of the provisions of the present invention, whether or not such cutting makes use of the custom-fitted platforms we have described.

### More General Uses for Tooling Platforms

Once the capability is available to attach a rigid tooling platform to an irregular object, it can then be seen that precise cutting is only one of a number of tooling processes that might be beneficial. For example, in some emergencies, it might be useful to drill holes in a damaged object. These holes could then be tapped, so that other devices, including plumbing fixtures, could then be attached.

### Creating Standard Connection Ports for Damaged Pipes

The method shown in FIGS. 3, 4, and 6 allows us to precisely and rigidly connect steel objects to irregular pipes. Based on this technique, we can now describe how to make the custom plumbing fixtures which are the subject of the present invention. We simply design a clamp so that it physically surrounds the leak area, and also includes standard connection port hardware.

In FIG. 7, we see a bent, damaged pipe 46 leaking oil. As in the example of FIG. 6, we could attach a custom clamp to a portion of this pipe, such as region 47 or region 48. But take a look at the clamp 50 shown in FIG. 8. By attaching to both sites 47 and 48, this clamp surrounds the leak, and provides a built-in pipe flange 55. A clamp of this kind is called a containment clamp. The clamp has a barrel-shaped interior space 54 designed to contain the leak-site. The clamp has flaps 53, also called flanges, which seal up the two sides of this barrel, and then, at the top, turning at a right angle, they create a the standard pipe flange 55, ready to be attached to a riser or cap for extraction.

### Some Scanning Issues

In designing such a clamp, regions 47 and 48 must be scanned so that their shapes are known. However, for the clamp to fit properly it is also necessary to know the precise spatial position and orientation of regions 47 and 48 relative to each other. One way to determine this is to provide the ROVs which perform the scan with some sort of precise positioning system. However, another method would be to scan the intermediate region 49 between regions 47 and 48. For, a precise geometrical model of all three regions would reveal the relative position and orientation of the two attachment regions 47 and 48. In practice, as much of a damaged pipe as possible would be scanned initially, and the attachment regions would be determined during the data analysis phase.

If optical methods are used, scanning may be complicated by the fact that some portions of a damaged pipe may be obscured by the plume of leaking oil. In the pipe shown in FIG. 7, this is not a serious problem. We don't need a full scan of the intermediate region 49, only enough of a scan so that we can determine the relative positions of parts 47 and 48. To achieve this, scanning the lower portion of region 49, where it is un-obscured by the oil, would be sufficient.

This won't always work. If a pipe was in a near-vertical position, with oil coming out the bottom end, such oil would then rise up around the very part of the pipe we would want to scan in order to attach a containment clamp. It may be possible to work around this by shooting a stream of water at the rising oil, in order to sweep it aside during the scan. This might not be hard to do. For example, the oil plume of the DH well was only moving at about 18 inches per second, and could easily have been temporarily swept aside by a high-pressure jet of water. An alternative would be to use other imaging technologies that can see through an oil plume, such as high frequency sonar.

### Another Containment Clamp

Now that we know how to make a containment clamp, we can go back and see how the pipe we scanned in FIG. 3 can be tightly capped without the need to make a clean cut at the top. Using the same digital object capture which was created to make the clamp in FIG. 6, a containment clamp 60 can be constructed, as shown in FIG. 9. Like the clamp in FIG. 8, this one creates a space 64 around the leaking pipe. This time the space has a somewhat more irregular shape, but it still has a standard flange 65 at the top, complete with mounting holes 56. This flange allows for a tight seal when an extraction device is attached.

### Concerning the Number of Attachment Regions

The clamp 60 has a somewhat simpler structure than the clamp 50 seen in FIG. 8. Since the pipe 20 is leaking oil from an end that is fully broken off, the clamp only requires the single attachment region 21 in order to enclose the leak. Clamp 50 requires two attachment regions because the leak is in the middle of the pipe, not at the end. There was a leak of this latter kind for some time during the DH spill, near where the riser was attached to the BOP.

### Auxiliary Ports

In addition to the round opening surrounded by the standard flange, containment clamps may also be provided with other openings, called auxiliary ports. Such ports, analogous in some ways to the choke-and-kill lines on the side of a BOP, may be used for various purposes. These might include the insertion of measuring instruments into the cavity, or the injection of fluids like methanol, or warm water, in order to discourage the formation of ice-like methane hydrate crystals. Such crystals led to the failure of the containment dome, an early capture device that was placed over the leaking riser of the DH well. Ports of this kind are not shown in the figures, but it is clear how they could be added.

### Joining Clamps

As we mentioned previously, custom-shaped clamps can also be used to join two pieces of broken pipe. In an oil-leak emergency, it helps to have as many options as possible, because unexpected situations may come up, calling for some degree of improvisation. One can easily imagine that in some cases, reconnecting two pieces of broken pipe might be useful. Looking at FIG. 7, we can imagine that the pipe shown there might have actually broken into two pieces near the leak-site shown. In order to reconnect those two pieces, we could use a joining clamp like the one 50J shown in FIG. 8A. Inside the clamp, shown in dotted lines, we can see the broken ends 49A and 49B of the two pieces 46A and 46B respectively, of the now-separated pipe. The clamp, creating a fluid-tight seal against the attachment regions 47 and 48 of these two pieces of pipe, encloses the broken ends within a barrel-shaped region 54 similar to the one within the clamp 50 of FIG. 8.

Joining clamps, such as 50J, don't need a flange like the flange 55 seen in FIG. 8, because the goal here is to contain the oil by connecting the two pieces of pipe, and to then allow the oil to flow through the sealed conduit formed by that combination. It is clear that a similar approach could be used to join 3 damaged pipes as one might normally do with a Y-shaped or T-shaped fixture. Similar fixtures can be made to connect 4 or more damaged pipes as well.

Although joining clamps can function without a flange 55, it may be advantageous to provide a joining clamp with an extraction port equipped with a standard flange. In effect, this would be a containment clamp that contains leaks from more than one pipe at once. Such a clamp could be fastened onto two or more target pipes, and extract or contain the oil leaking from all of them, provided it was able to handle the flow. We don't include a figure that shows such a clamp, but it is easy to imagine how it would appear. Looking at the clamp 50 of FIG. 8, we can imagine that the pipe 46 was actually broken into two separate pipes 46A and 46B, just like the pipes seen in FIG. 8A. Visualizing clamp 50 attached to these two separate pipes, we can get a clear picture of what a joining clamp with an extraction port would look like.

### Choosing the Attachment Regions

A clamp may have two or more plates. Each plate, when moved into place, will cover a particular portion of the attachment region, and these portions, when combined, comprise the entire attachment region. Not any such portion of the attachment region, however, is suitable to be the area covered by a single plate. In order for it to be so covered, the portion has to have a particular mathematical property which we will call the placement chart property. A patch of surface is said to have this property if this patch can be described as the graph of a function z=ƒ(x, y), subject to a properly chosen orthonormal coordinate system. If this is true, it means that a plate could in principle be moved into contact against this surface patch by moving it in a direction parallel to the z axis.

In practical terms, however, this will only work well provided that the function ƒ(x,y) is not too steep. In places where it is very steep, the plate will be moving nearly parallel to the target surface as it is being pressed into position. Movement of this kind could lead to jamming, and so should be avoided.

What this means is that some care may be required, when designing a clamp, in choosing how many plates it will have, and where the boundaries of those plates will be. These decisions can be made using computer-graphics software. Engineers skilled in designing clamps, or clamp-like objects (such as, for example, aircraft doors) will likely be able to select proper attachment regions and plate boundaries for a clamp. Once these boundaries are determined, other software can be used to simulate the trajectory of movement taken by the plates as they are pushed into place. These simulations may be able to reveal if jamming might be a problem. If so, the attachment region or the plate boundaries can usually be altered so that there will be more favorable angles for the installation movements. In some cases, however, there may be cavities in a surface which would be very hard to match at all with a clamp having only several pieces or less. An example of this kind is examined our discussion of FIGS. 10A-10C, in a later section.

### Shape Design

Looking at the containment clamps of FIGS. 8, and 9, it is instructive to consider how the shapes of the enclosures and flanges are determined. In fact, much of that decision is somewhat arbitrary. The basic functional requirements for a containment clamp are as follows:
(1) The enclosure formed by the assembled clamp should connect the pipe-matching area of the clamp (the part that fits onto the chosen attachment area on the pipe) to a standard round flange, with bolt-holes.
(2) Except for the standard flange opening, and any auxiliary ports, the enclosure should provide no means of escape for the fluid leaving the enclosed pipe.
(3) The plates of the clamp should each have their respective matching flanges so they can be bolted together.
(4) The plates should have adequate thickness so as to provided such strength and rigidity as the assembled device may need in order to stay in place and not break.

Comparable, simpler conditions would apply to a joining clamp like the one shown in FIG. 8A. Provided these conditions are fulfilled, the shape of the enclosure itself is not particularly critical. In the examples we have shown, the clamp encloses a barrel-shaped, roughly cylindrical space. However, containment clamps could be made in which the enclosed space would look more like a sphere, or a box, or even a truncated cone. Once scanning data is available, engineers with experience designing industrial plumbing fixtures would be able to create a digital model of this device on a CAD station in as little as an hour or two, perhaps even less if they were part of a team that had trained for this kind of an emergency.

### Response Time

Speed is important because, at a leak rate of 50,000 barrels per day (that of the DH well) one barrel of oil enters the water every 1.73 seconds. We believe that with proper preparation and staging, response teams trained in the method of the present invention could scan pipes, design and build a custom clamp, and install it, all within a matter of a few days, at a cost which would be only a tiny fraction of the overall cost of the damage caused by an ongoing leak. In other words, this technology is extremely economical, when the huge cost of oil leaks is taken into consideration. In order to reduce response time, it makes sense to set up clamp manufacturing sites that are near to the areas where emergencies may occur, such as the Gulf of Mexico.

### Who Will Make the Clamps?

We believe it would be a good idea to set up manufacturing sites where these clamps can be produced quickly and reliably when needed. During non-emergency periods, which may last for many years, these sites would produce clamps for training and testing in deep water, as part of preparedness exercises by response teams.

In order to increase the odds that at least one such manufacturing site will be ready if and when the next deep-water BOP failure occurs, it would be advantageous to organize clamp manufacturing activity so that work sites could participate without having to dedicate their facility full-time to oil-containment preparations. Yes, it would be good if there was at least one dedicated site, but given that there is going to be competition for oil-containment preparation funds, a part-time participation program could increase the number of sites with at least some experience.

Many organizations which have suitable equipment, such as large, digitally-controlled machine tools capable of working steel, would have a natural interest in participating in a program of this kind. It would be clear to them that, in the event of another BOP failure, their facility would be in a position to provide a specialized emergency service which could make a huge difference in the “capping time” for the resulting oil spill, and thus also in the total amount of oil released over the course of the disaster.

Organizations worth approaching to see if they would like to participate in a program of this kind would include industrial corporations, universities, and also military branches such as the U.S. Navy or the U.S. Coast Guard. It is also likely that oil companies themselves, either singly, or jointly as part of a combined oil-spill response task force, will have resources to offer.

It is important to realize that manufacturing capacity of this kind anywhere in the world would make a huge difference. Bearing in mind that a major oil spill would be a national emergency, it is likely that the air transport capabilities of the U.S. military would be offered to help deliver manufactured clamps to the installation site. Thus, even if the clamps are built 12,000 miles away, only about 3 days or less would be required for the clamps to be delivered.

Another logistical tactic that should be considered is the concurrent production of multiple clamps for the same target site, as a way of increasing the odds of success. One manufacturing team might produce a 2-piece clamp, another a 3-piece clamp. Different teams might choose different attachment regions and different plate dividing lines, based on the same digital scan of the target object. The result might be that, if one team's clamp could not be properly installed, or failed to seal, another team's clamp might succeed.

### Crisis-Driven Resource Allocation

When planning for an emergency of this kind, it is important to realize that, once the crisis actually starts, there may be a lot of willingness, on the part of many organizations, to help. Also, because of the huge costs of an ongoing leak, the cost of response operations once a leak is in progress, compared to normal industrial process costs, may become an almost negligible factor. [C] This creates a rather uncommon situation for planners—strategies should be favored which can work successfully with an expectation of normal or even somewhat low budgets in the preparation phase, but an expectation of very large budgets once a crisis is actually underway.

### Other Organizational Factors

If the devices described in the present invention are to be used in the most effective way, or even if they are to be used at all, logistical and organizational factors must be taken into account. Most modern disaster investigations have come to the conclusion that “organizational culture” is a major contributing factor in understanding, managing, preparing for, and responding to the risk factors which any large project will involve.

The final report of the National Oil Spill Commission reached exactly this conclusion in their analysis of the causes of the Gulf oil spill of 2010, finding a kind of complacency, a lack of thoughtful appreciation of risk, in the corporations involved, as well as the government agencies which regulate them. (See [OSC Recommendations], p ix.)

It is not easy to quantify what it would take for an organizational culture to adequately support the successful use of a particular safety device or process. Nevertheless, however, such qualities are in fact essential to the proper use of any safety technology. We will have more to say about this later on, in our concluding remarks.

### Further Considerations

Next, we take a look at some further details of how this process works, what it can do, and what it requires.

### Clam Size Must be Adjusted in Manufacturing for Temperature-Contraction

Ever had to run hot water over a metal jar lid to get it off? Well, that's not so easy to do at 5000 feet under the sea. These clamps are going to contract due to the cold, when they are moved from the surface to the depths. In order to compensate for this, they will be manufactured slightly oversized. A mathematical model of the expected contraction will have to be chosen, and employed to slightly expand the digital scan of the target surface before it is used to make molds or to control cutting tools for the manufacturing process.

### Use of Gaskets

In addition to the custom-shaped steel clamp itself, we may also want to make a custom-shaped gasket from rubber, or some similar material. Gaskets may be found to be advantageous because they can compensate for small inaccuracies in measurement that could lead to discrepancies between the shape of the clamp and the shape of the pipe.

Similar, custom-shaped items are often made in the film industry, for special-effects masks and prostheses. We may also want to consider coating the clamp, in the areas where it contacts the target surface, with some kind of sealing resin. However, this option should be considered with caution because it may make the clamp difficult or risky to remove, should that be necessary. Also, working with resins at ocean depths, by means of ROVs, is not a simple matter. We recommend gaskets be used rather than sealants.

The manufacture of a custom gasket requires an extra step beyond what is needed to make the clamp itself. The pieces of the clamp can simply be cut from a single block of steel, using a computer-controlled milling machine, once they have been digitally modeled. Gasket materials can't generally be cut in that way, so the gasket will be created by casting in a steel or aluminum mold that is machined from a digital model.

There is, however, an alternative to casting that is worth mentioning. It may be possible to create the equivalent function of a gasket by spraying a thin coating of gasket-like material onto the inside surfaces of the clamp. Think of a substance that can be sprayed like paint, but which, when dried, becomes a rubbery material. A method of this kind should be explored along with the casting approach.

FIG. 5 shows an edge-on view of the simple clamp 30 seen in FIGS. 4 and 6. The pipe 20 is shown in cross-section, here creating a seal against the surface based only on metal-to-metal contact. It should be emphasized that metal-to-metal contact may be found, in research and development of this technology, to be sufficient as a sealing method.

In the event that gaskets are found to be a better approach, a few issues are worth pointing out. FIG. 5A shows a detailed view of a clamp similar to the one in FIG. 5, but with a gasket 36 in use. When a gasket is to be used (say, for example, one with a thickness of 1 mm to 3 mm) this will actually change the shape of the steel clamp that must be made, because that clamp is now fastening around a somewhat larger object—the pipe surrounded by the gasket—rather than directly around the pipe itself.

If the walls of the clamp are made close to their the minimum tolerance required for appropriate strength and rigidity, the clamp may look slightly thicker from the outside, as compared to one that was built for use without a gasket.

### Gasket Flaps may be Needed

The gasket style shown in FIG. 5A has a feature that could be problematic in terms of leakage. There are two thin strips of surface where the edges of the two sides of the gasket meet. We call this the gasket meeting surface. The width of these strips is the thickness of the gasket itself. The end of one of these two strips is indicated in FIG. 5A as item 36M. The problem is that, inside a containment clamp, a “crevice” of this kind may be directly exposed to the fluid being contained. If this fluid seeps into the space between the edges of the two gaskets, it might then escape into the adjacent metal-on-metal region where the two clamps meet. Because of the geometry and force-structure of the clamp, there may not be enough force being applied to press the two sides of the crevice at 36M together so as to form a fluid-tight seal.

The solution to this problem is to extend the gasket part way, or even all the way, into the boundary between the plate-to-plate portions of the clamp, creating the gasket flap area 37 seen in FIG. 5B. General engineering practice regarding gaskets, as well as further research and development, will make it possible to determine the advantages and disadvantages of these several sealing approaches.

Properly designed gasket flaps can also be used to compensate, in some cases, for problems which may occur in the tangential installation region at the edge of a 2-plate clamp, as described above in our structural discussion of FIG. 15A. By shaving just a bit of the clamp material off this edge (marked by the point P0 in FIG. 15A) one can somewhat reduce the scraping problem. To compensate for this loss of material, extra volume can be added to the gasket. Because of its softness, the gasket will be more accommodating if scraping is encountered during the installation.

### Pre-Attachment of Gaskets

Positioning a flexible gasket on a pipe, or within a clamp, is not something an ROV can easily do. Thus, the preferred method for attaching the gaskets is to seal them onto the inside of the clamps on land, using a suitable adhesive. Bearing in mind that the clamp, preferably made of steel, will expand and contract at different rates, based on temperature, than will the gasket, it may be a good idea to perform the gasket sealing in a low-temperature environment that simulates that of the ocean depths. Logistical preparations for an oil-spill emergency might therefore involve providing such a low-temperature environment and testing the gasket attachment process using that environment. A cooling room, or a refrigerated truck, could be used for this purpose.

A related problem created by the difference in expansion rates between gasket and clamp is that the gasket may tend to detach itself if the clamp warms up while it is being shipped to ocean installation site. This problem can be dealt with in a number of ways. One method would be to pack the clamps in cooling and insulation layers for transport. It might be easier, however, to simply use gasket and adhesive materials that can withstand expansion and contraction without tearing or breaking.

### Where do you Put the Clamp?

This may seem like a silly question, but when you are working via ROVs, in poor visibility conditions, it is reasonable to ask, how do we position the clamp in just the right place? If we think it's properly positioned, and we try to tighten it, and it's not in just the right place, it could jam, or even damage the pipe. Another bad outcome to avoid would be that the clamp, as it was being tightened, might press rigidly against the pipe, but not quite in the right position. Being in the wrong position, it would not seal properly, and it would have to be loosened up and repositioned before being tightened again.

There are a number of ways to get proper positioning. One method is to use the same object scanning technology that was used earlier to do the object capture. As an ROV is approaching, holding the clamp, the scan is repeated, digitally locking onto the region that was scanned earlier. Once this lock is achieved, software can be used to create a coordinate system—effectively a virtual grid—which is rigidly aligned with the target object. Projecting this grid onto the view-screen used by the ROV operator will allow him to see precisely where he has to put the clamp. In effect, we have made a digital mark on the pipe, visible on the ROV view-screen. There would even be the option of automating the motion of the ROV, once a position lock has been achieved.

Other methods would involve making an actual physical mark at the time of the original scan. Some processes for clamp placement may, like the scan itself, require digital electronic positioning of the ROV.

More can be learned about positioning issues during the testing and development of installation methods for the clamps we have described. This will probably involve a combination of actual underwater testing, together with computer simulations of the installation process.

### Cavities Can Place Limits on the Geometry of the Clamped Area

There are some important limitations on the shape of an area we want to clamp onto. For our method to work, the shape can be quite irregular, as we've seen. However, if the surface contains certain kind of features, such as cavities that expand inside a smaller opening, it will not be possible to match the surface with a two-piece clamp, or even with a manageable multi-piece clamp.

FIG. 10A shows a cross-section view of a pipe 67 with just such a cavity 68. We could make a clamp that would fit around the pipe, but we would have to skip the cavity, as shown in FIG. 10B. If the cavity extends lengthwise down the pipe, as shown in FIG. 10C, the unsealed portion could allow for oil leakage.

This kind of limitation is important because, in practical cases, it may mean that we are limited to certain particular areas on a piece of equipment, areas that allow us to form a tight seal with this kind of clamp. Areas where the geometry is too convoluted may have cavities of the kind we have just seen, preventing us from making an adequate clamp to seal against them.

### Different Positioning of Extraction Ports

The containment clamps of FIGS. 8 and 9 both have standard adaptor flanges (parts 55 in FIGS. 8, and 65 in FIG. 9) to allow for the attachment of other containment or extraction plumbing. These flanges may also be called extraction ports. In each of these two clamps, the extraction ports have a “split flange” construction in which the adaptor flange is formed out of two separate pieces, one piece from each plate of the clamp.

However, it is also possible to make containment clamps where the extraction port is entirely contained within a single plate. In order to see how this can be done, consider the joining clamp 50J shown in FIG. 8A. Each of the two plates 51 and 52 of this clamp enclose a region roughly shaped like half of a barrel. These two half-barrels combine to form the barrel region 54 which encloses the broken ends 49A and 49B of the two pipes. An extraction port could easily be added to the clamp by integrating the port into the wall of the half-barrel portion of one of the plates, say the front plate 52. After doing this, we would then have a clamp with an extraction port contained entirely in one plate.

Much the same thing could be done with the clamps 50 and 60 shown in FIGS. 8 and 9. An extraction port could be added to one side of the clamp. We can then imagine that the split flange connector at the top of these clamps could be replaced by a simple continuation of the clamshell flanges (53 and 63), so that the top parts of the clamps would now look like the top part of clamp 50J of FIG. 8A.

Extraction ports that are integrated into a single side of clamp are common in the prior art. For example, the patents of Eaton, Ottestad, and Vu, in the Reference Documents section, each include a port of this kind, described variously as a branch line, branch pipe, or branching pipe-socket. For this reason, we haven't included a figure illustrating this kind of port.

Another kind of approach can be used to integrate the extraction port into a single plate. Looking at the front plate 62 of the clamp 60 seen in FIG. 9, imagine that this plate was only half as tall as it, extending upward only a few bolt-holes beyond the top of the attachment region 21, and joining there, through a new, horizontal portion of the flange 53, with a larger version of the rear plate 61. Modified, this way, the expanded rear plate would now enclose about ¾ of the barrel 64, while the smaller front plate would now enclose the remaining ¼ of the barrel, that being the lower front part.

With a modification of this kind, the extraction port at the top of the clamp would now be entirely contained in the expanded rear plate. We haven't included a drawing of this kind of clamp, but we think it will be clear how one could be constructed.

### Sealing a Leak Similar to the Deepwater Horizon Oil Leak

The two containment clamp examples we have looked at so far have been for cracked or broken pipes. During the time that the bent, collapsed riser pipe in the Gulf was still attached to the Deepwater Horizon BOP, our methods would have been easily applicable. However, unfortunately, the present applicant only discovered this approach on Jun. 2, 2010, the same day that BP sheared off the riser pipe just above the BOP. At this point, it appeared, from the available views, that there was somewhat of a shortage of appropriate surfaces on the top joint of the BOP where one of our clamps could be attached. Eventually, on July 15, the leak on the DH BOP was fully closed with a tight sealing cap. If leaks occur in the future under similar conditions, we believe our approach could provide another method for sealing them, as we will now describe.

FIG. 11 shows a rather approximate drawing of the top of the DH BOP. The regions 71 and 72 are places where we might reasonably expect that a clamp could be fitted. However, region 74, enclosed in an oval outline, has the more complex kind of geometry examined in our discussion of the cavity seen in FIGS. 10A-10C, so it probably can't be sealed by the methods we have presented here. [S]

One possibility would be to try to cut away some of the other equipment that seems to surround that part of the pipe, in order to get a more accommodating surface. Whether ROVs could do that is a question that would have to be addressed. In addition, there may be risks in trying to cut away the extra parts, including the danger of creating possible additional leak sites, potentially more severe than the one already present.

We are thus left with sites 71 and 72. It appears that those surfaces are suitable for our method, and could be tightly sealed. FIGS. 12A, 12B, and 12C illustrate clamps, shown in cross section for clarity, which attach at site 71, or site 72, or both.

Both of these sites have rather small surface area compared to the larger expanses of pipe we were able to seal to in the previous clamps of FIGS. 8 and 9. Small surface area could be a problem both in creating a good seal, and in providing adequate mechanical support. Mechanical rigidity is important because forces on both the BOP and the clamp itself could disrupt the seal if there is too much leverage and not enough area of contact.

In order to compensate for this small surface area, we propose to use the clamp shown in FIG. 12C, which seals to both of the regions we have identified. The result is shown in FIG. 13A. Although the geometry of this clamp 80, in its attachment region, is more complex than what we have seen in previous clamps, the basic concept remains the same. The clamp is a transitional plumbing adaptor device with a standard flange connector at one end, and a “whatever-it-takes” connector at the other end.

This latter connector—the custom-made part—wraps around the top joint of the BOP. It has a rather interesting shape, one which isn't fully visible in this figure because it is hidden behind the plumbing flange of the top joint. FIG. 13B shows a more detailed view of this bottle-in-a-bottle-shape.

Because of the small area of contact provided by this clamp, there may be a need for extra mechanical support. A clamp of the kind shown in FIGS. 13A and 13B might be given such mechanical support by attaching it to a framework of girders and beams that would tie in somehow to sturdy areas lower down on the BOP, as shown in FIG. 13C. [G] The clamp is manufactured with brackets 89A which attach to the girders.

Proper mechanical support may be a serious matter in a situation of this kind. First of all, there is the weight of the clamp to consider. An attachment region with only a small area may not be able to support this weight without breaking its seal. Additionally, there will probably be even greater weight involved once an adaptor or cap is attached to the standard flange at the top of the clamp.

The mechanical effect of the flowing oil must also be considered. Because of potentially high pressures, methane bubbles, and turbulence, any cap used to cover a leaking BOP may be subject to vibration and buffeting from the oil flowing within it. These might create lateral forces on the clamp which would produce leveraged torques in the area of the seal.

Without proper additional mechanical support, these torques might eventually degrade the quality of the seal, or even dislodge the clamp. If that happens, there could be a risk of breaking something in the area 74 (in FIG. 11) below the flange, making the leak even worse.

The clamp 80 has a standard flange 85 at the top which can be used to attach a tightly-sealed cap similar to the one which was eventually installed successfully on the top joint of the DH BOP. Our approach has the advantage that it does not require taking apart the top joint of the BOP, an operation which may take greater time to plan, because of the risks involved. Also, in some cases where a BOP has been damaged, removal of the top flange may not be possible at all.

### Three-Plate Clamps

The containment clamps we have examined so far, in FIGS. 8, 8A, 9, and 13A-13C, have been two-plate clamps. As it happens, two-plate clamps have a particular disadvantage which, when understood, leads to an interest in 3-plate clamps. The problem with 2-plate clamps is that they can jam at their edges while being moved into place. We have seen why this is so in our previous discussion of FIGS. 15A and 15B. Each plate of a 3-plate clamp covers only 120° of the angular extent of the target object. As a result, when a point on the inner surface of the clamp is approaching the target object, the angle between its direction of motion and the plane of the object's surface will remain above 30°. In contrast, at the extreme points of a 180° plate (a plate for a 2-plate clamp), this same angle will be 0°, representing a fully-tangential movement. Tangential movement of this kind is likely to produce scraping and jamming.

Jamming is a serious matter when you are doing something with an ROV. When you are operating an ROV, you don't have the kind of fine-motor control or sense of touch that you would have when using your hands, either on land, or underwater at a depth where human beings can work using SCUBA or diving suits. If something is going to be done with an ROV, it has to be a simple motion, and one with rather high placement tolerances.

With this in mind, it may be determined, with further research and experimentation, that two-plate clamps are not such a good idea under certain conditions at ocean depths where only ROVs can operate. Three-plate clamps provide an alternative for such situations.

### Ease-of-Design Advantages of 3-Plate Clamps

There is another significant advantage to 3-plate clamps worth mentioning here. The process of choosing attachment regions on damaged pipes, and then digitally designing the clamp to fit those regions, could well be easier and faster when designing a 3-plate clamp.

Why is that? In order to see this, first imagine that you are sitting at a CAD station designing a 2-plate clamp for a perfectly cylindrical pipe. Each of the two plates must precisely match an exact half-cylinder on the pipe's surface. A plate that covers more than 180° of the pipe will be impossible to slide into place. Now, imagine the same design task, only this time, the pipe is only approximately cylindrical. It may have distortions, dips, bumps and ridges here and there. Because those dips and bumps are present, the exact location of the flange plane for the two-part clamp is critical. You can't put that plane, or the two lines where it intersects the pipe, just anywhere on the pipe. You have to be careful to avoid dips and bumps that may occur very close to the edge of a plate, in the region where the installation movement is nearly tangential, as explained in the structural discussion of FIG. 15A. Failure to find a proper site for the dividing line between plates can create problems analogous to those we have seen in fitting a 2-plate clamp on the clover-shaped object of FIG. 14. There, the problems were large and easily visible, but similar problems can occur even with very small bumps and dips, when those variations happen to occur within the tangential installation region.

This extreme sensitivity to exact positioning doesn't come up, however, when designing a 3-plate clamp. There, even at the extreme edges of the plate, the angle made by the approach-motion vector with the tangent line is around 30°, well above the 0° we see in the tangential installation region of a 2-plate clamp.

The precise positioning of the plate dividing line on the pipe is, in consequence, far less critical. Moreover, while 2-plate clamps must each encompass exactly 180°, the plates of a 3-plate clamp are not restricted in this way. Some of the plates can be a bit over 120°, while others are a bit under. This distribution of angular span can even be varied over the length of the pipe, if necessary, in order to accommodate the valleys and ridges which may be present in the pipe's shape.

A simple example of a 3-plate clamp is shown in FIG. 15. FIG. 16 shows how a 3-plate clamp might be designed for the same leaking pipe sealed by the 2-plate clamp shown in FIG. 8. FIG. 17 shows another example of a 3-plate clamp, this one having curved flanges.

### Curved Flanges and Their Advantages

In all of the clamps we have seen so far, the flanges have been flat. However, there is no reason why these clamps cannot be made with curved flanges. Moreover, there is a specific advantage that can be obtained by allowing curved flanges to be used in clamp design. We have seen previously (in our discussion of FIGS. 14, 15, 15A, and 15B) that significant care may be needed in the selection of the proper attachment regions, and, within those regions, the selection of the boundaries between the areas covered by particular plates. If these boundaries are allowed to be non-planar lines, this adds greater flexibility to the choice of the boundaries. However, if non-planar lines are allowed as boundaries, we may end up with flange surfaces which are curved.

Curved flanges do not pose a significant problem, we believe, in the design, manufacturing, and installation phases for these clamps. However, they do require a refinement in order to properly accommodate nuts and bolts. When nuts and bolts are used to fasten two curved surfaces, it may be necessary to add extra material to the surfaces in order to provide a flat area for the nuts and bolts to press against when tightened. In addition to this, it may also be necessary to allow space around the nuts and bolts to provide clearance for installation tools.

One way to do this is by using bolt-collars. FIG. 17 shows a 3-piece clamp 120 with two mated curved flanges 53-1 and 53-2, in the foreground. The bolt-collars are the three cylindrical objects 35C emerging from flange 53-1. Similar bolt-collars are part of flange 53-2, but they are not visible in this figure. It is recommended that bolt-collars on curved flanges be arranged so they have parallel axes, as shown in the figure. The reason for this is that parallel axes for the collars mean that bolts are installed in parallel directions. This simplifies the installation process, and simple installation is important since the work will be carried out by ROVs. Parallel bolt-collar axes may also make it easier to test the assembly and installation procedures via computer simulation, an essential part of the design process.

### Conclusion

In a previous section, we examined questions including who would actually build these clamps, how much the manufacturing facilities would cost, and how the clamps would be delivered to the leak site. These are important factors to consider in describing the preferred way to use the clamps, because any factor on which effective oil containment critically depends is, for that reason, necessarily important.

There is no such thing as a device which can be successfully used without infrastructure. Any safety system, even one that is based on mechanical equipment, even one that is based on supposedly automatic equipment (such as an oil-well blow-out preventer), will not succeed unless a complex web of interconnections provides that system with all the resources it needs in order to function. These resources may include delivery services, funding, electrical power, and the proper education of the people who use and maintain the system.

In their final report, the National Oil Spill Commission identified, as one of the primary causal factors of the Gulf oil spill of 2010, what they described as an “organizational culture” in the oil industry which was not sufficiently alert to risk. Similar problems were found to exist at the government agencies charged with the regulation of the oil industry. (See [OSC Recommendations], p ix, p 12.)

In fact, investigations of nearly every major engineering disaster which has occurred over the last several decades have found that similar problems in organizational culture, or management culture, were central causes of tragic events. Such disasters range from the loss of two NASA space shuttles, to the Chernobyl explosion, to the effects of Hurricane Katrina, to the explosion at the Upper Big Branch coal mine in West Virginia. Such disasters include the Deepwater Horizon blowout itself, and more recently the partial meltdown of 3 reactors at the Fukushima Daiichi Nuclear Power Plant in Japan.

What this tells us is that a crucial component of the infrastructure required to use the devices described in this invention, or any oil-containment technology or method, is the beliefs, habits, and attitudes of the people who work in, and who regulate, the oil industry.

In their final recommendations, the Commission quotes investigators of the loss of the space shuttle Columbia, who pointed out that “complex systems almost always fail in complex ways.” (See [OSC Recommendations], p viii.)

Technology, especially fault-tolerant technology, is often subtle and complex in how it works. But surely the kinematics of organizational culture are far more complex than that. The human brain is the most complex device of any kind that we know of, and the intricate patterns of organizational culture involve many if not all of the capabilities and dynamics of human thinking and feeling.

The devices we invent and discover won't work for us if people don't know how to make them work. Equipment ranging from smoke-detectors, to voting machines, to nuclear reactors, to huge oil rigs like the Deepwater Horizon, can and do fail if the people responsible for using them, for managing them, for maintaining them, don't understand what to do, and what not to do.

Technology has given humanity ever-increasing power, and there is every sign that it will continue to do so for as far into the future as we might care to imagine. That power is potentially a very good thing. However, with such power comes a responsibility, the responsibility to know how to safely and fairly use the powers which technology has given us.

Technology is itself the product of human creativity. In this new century, however, we are beginning to see with poignant and disturbing clarity that there is another kind of human creativity, a new kind of human creativity, of which we seem to be in seriously short supply.

This new kind of inventiveness, if we can manage to bring it forth, will reveal ideas about how we can educate ourselves and each other in the wise, responsible, and balanced use of technology.

It will be, in effect, a new kind of technology, a technology of wisdom, of responsibility, of understanding. A technology of growing up into the new kind of adults, the new kind of leaders, the new kind of citizens which the new world we are creating, and hurtling inexorably toward, will require us to be.

This new technology, a proactive technology of care, caution, balance and thoughtfulness, is really what investigators of so many modern tragedies are asking for when they talk about the need to change “organizational cultures.”

In the above technical discussion, we focused on explaining how our device works, and how it can be used. We didn't talk much about what has to be going on inside people's minds and hearts in order for them to use it, or to use any safety technology, in the right way, or even to decide to use it at all. And yet, as we and so many others have pointed out, devices don't get the job done on their own. They need us to help them do it. And they need us to have the right kinds of attitudes, awareness, and understanding, or the devices won't work.

We hope that the invention we have described here will be of value in containing future oil spills, if and when such oil spills may occur.

More than that, however, we hope that developments in the “technology of ideas” will lead our world to new understandings, new ways of thinking which can become the basis of a new kind of organizational culture, one that gives safety and caution their rightful place in the planning and implementation of the many projects which humanity chooses to undertake.

### A Memorial Note

The invention we have described here is only an oil containment device, not a means of preventing blowouts from occurring in the first place. The correct operation of oil-well blow-out preventers is not just a matter of protecting our ecosystems and our economy. It is also a matter of life and death. Eleven men lost their lives on the Deepwater Horizon oil rig on Apr. 20, 2010. Mindful of the loss suffered by these men and their families, it is our hope that oil companies and the agencies which regulate them will in the future become increasingly vigilant and effective in all matters of safety, and take whatever steps may be required to protect the lives of the men and women who work in the oil industry.

### Notes

### [D] Digital Object Capture

Digital object capture is a process by which a detailed, high-resolution digital geometric model of a physical object is created. Object capture can be done by a laser scanning process, by using sonar imaging, by stereo imaging (possibly using special lighting), or by some combination of these methods. Mechanical casts can also be used in this process.

Another mechanical method that is sometimes used is to physically trace lines on the object's surface with a position-measuring mechanical stylus. A stylus of this kind can be thought of as a form of electronic pantograph. As it moves, electronic servos measure the angles and/or distances of movement of the stylus so that its position in three-dimensional space can be calculated, and recorded digitally.

In each of these approaches, data is collected which is then processed in various ways to create a mathematical model of the object inside a computer. In the interests of speed, it may be necessary to settle for imperfect accuracy in the scan, and attempt to make up for that with a compressible rubber gasket.

### [C] Response Budgets

The huge per-day cost of oil-spill damage made it sensible for teams to spend whatever was necessary in the response effort to the Deepwater Horizon Oil spill:
Each team concentrated on a discrete containment effort, like actuating the BOP stack, developing near-term options to collect oil from the riser, or stopping the flow through a “top kill” procedure. Each team also had what amounted to a blank check. As one contractor put it, “Whatever you needed, you got it. If you needed something from a machine shop and you couldn't jump in line, you bought the machine shop.” Several MMS officials agreed that, for BP, money was no object: If a team needed equipment, whether it was a ship, freestanding riser, or flexible hose, BP would buy it.

([OSC Working Paper 6], p 5.)

### [G] Girders and the Flex Joint

The framework of girders 90 shown in FIG. 13C may present a flexibility problem. The top joint of a BOP, called the flex joint, is normally required to be able to flex back and forth a few degrees in order to accommodate small changes in the angle of the attached riser pipe. A rigid framework of girders like that shown the figure would interfere with this flexibility. This issue could be handled by adding some flex to the girder framework, but that might not be necessary because flexible hoses would probably be used for oil extraction, reducing somewhat the demand for flexibility in the top joint of the BOP. In all likelihood, the oil capture and extraction phase, as with the DH well, would only be a temporary process, pending the eventual killing of the leaking well by means of a relief well. It would not be necessary to attach a conventional riser pipe during this time, since there would likely be no need to lower drilling tools into the well.

### [M] Digital Machining

The simplest way to make an object of this kind is to start with a single large block of steel, and cut away the excess. Modern computer-controlled machine tools can do this based on a mathematical model of the clamp, created at an industrial design work-station by adding flaps, enclosures, and other features to the model we got from the object-capture on the irregular pipe. In some cases, a casting is made first that approximates the shape desired. Then, computer machining is used to trim the excess from the casting so as to create the final object.

### [S] Sealing of Complex Regions

Sealing a region with the kind of complex geometry we see in the area just under the top flange of the BOP (region 74 in FIG. 11) is a task that would likely require the use of resins, or other substances which can be put in place in liquid form and then allowed to harden. Concretes and cements would be options to look into for sealing tasks of this kind.

### [T] Underwater Machine Tools

The National Oil Spill Commission has recommended that we explore new technologies which might allow for improvement in the response to future oil spills. (See reference “OSC Recommendations”, pp 24-34.) Clearly, deep-water remotely-operated machine tools are an example of such a technology. It is possible that the U.S. Navy or the U.S. Coast Guard may already have precise underwater machine tools. Partnerships with these organizations will be part of the ongoing effort to prepare for the next oil spill, and the technology of remote underwater cutting should be an element of this.

### Scope of the Invention

In the above discussion, we have focused on the application of the present invention to compromised BOP stacks. However, the present invention can be helpful in other kinds of situations as well. Variations in particular aspects of the devices, dimensions, materials, and methods we have described can be envisioned which do not substantially alter the content or significance of the ideas we have proposed.

It is our intent here to include this broader range of situations, processes, and configurations within the scope of the present invention, as detailed in the claims to be set forth below.

More specifically, below are listed some of the generalizations we intend to include in the scope of the current invention.

### Context of Application

The distinctive application features which may serve to make the present invention beneficial and cost-effective in a particular circumstance are as follows:
(1) The source of the leaking fluid cannot simply be turned off while repairs are undertaken.
(2) Removal of an existing flange or other plumbing fixture may be difficult, costly, impossible, risky, or time-consuming.
(3) The damage caused by a leak, and the perceived probability of such a leak, would justify redundant or back-up preparation measures allowing for rapid, safe response to such leaks.

In addition to oil-well blow-out preventers, examples of situations where one or more of these factors could be present might include certain pipe-lines, water mains, drainage pipes, dams and spillways, hydroelectric plants, and plumbing associated with chemical plants or nuclear reactors. Emergencies of this kind could also occur in laboratories or manufacturing facilities where chemically, biologically, or radiologically hazardous substances are created, processed or stored. Such crises could also occur in manned or unmanned space-vehicles, where the scarcity of various fluids, and the risk associated with their loss, could be a critical factor.

### Dimensions

The relative dimensions shown in the figures are only for purposes of illustration. Actual dimensions would be determined by engineering considerations relating to the specific context of application. No particular size is intended or implied. The size of the plumbing devices employed could range from the microscopic, up to the scale of the very largest plumbing in use, such as might be found in water mains or dams.

### Materials

Steel is currently the preferred material used in industrial plumbing. New materials are constantly being discovered and invented, however, and all of the devices and procedures described here could be adapted to different kinds of materials. An important specific example of an alternative material for use in these clamps would be concrete, including reinforced concrete. One can imagine situations where it would be of great value to rapidly manufacture a custom-shaped plumbing fixture out of reinforced concrete, in order to respond to an emergency, such as one involving a broken water main.

### Process of Manufacture

Some materials, such as certain ceramics, can be cast, but not readily cut with machine tools. In such a case, computer-controlled machine tools could be used to make a steel or aluminum mold which would then be used to make the object itself.

Various types of materials, such as certain plastics, can be created in a digitally-determined shape by a computer-controlled layer-deposition or granule-deposition process, such as that used in 3D object printers. Certain computer-controlled methods, of this general kind, for making 3D objects can potentially be used as a substitute for digital metalworking in the manufacture of the clamps we have described.

### Means of Fastening

Our description of how the clamps of the present invention are built and installed can be seen to be compatible with any fastening means which is mechanically adequate for the application, and also suitable for the equipment used to perform the installation, such equipment generally being underwater ROVs when the context of application is a deep-water oil well. Steel nuts and bolts are the standard fastener used in most industrial plumbing applications. However, we include in the scope of the present invention the possibility of other kinds of fasteners.

### Shape of Plates

The containment and joining clamps shown in our drawings illustrate a certain style of how the shapes of the plates, and the locations of the mating flanges, can be designed. However, there is considerable flexibility in the choice of plate shapes and mating flange locations. (See previous sections “Shape design” and “Different positioning of extraction ports”.) Our intent is to include in the scope of the present invention a broad variety of plate shapes and flange locations, beyond that shown in the specific examples we have presented.

### Attachment and Incorporation

When presenting a drawing or description of an object, it may be convenient to distinguish between features or parts which are provided by attachment, and features or parts which are provided by incorporation. For example, the handle of a fork, spoon, or similar utensil may be a separate piece of material attached to the body of that utensil, or, alternatively, the handle may be incorporated or included in that same single piece of material.

This distinction between attachment and incorporation is relevant to the scope of the present invention (and indeed to that of many inventions) because it is often true that the actual function of a part or feature is relatively independent of whether it is provided in the invented object by means of attachment or by means of incorporation. This may be true despite the fact that, in the examples presented or illustrated, a particular choice may have been made as to which parts or features are provided by attachment and which are provided by incorporation. This choice may be made for purposes of expository clarity, or for the purpose of describing a preferable embodiment, even though both choices would be reasonable embodiments of the device being described.

Our intent, in the claims to be set forth below, is to include the possibility that certain features may be provided either by attachment or by incorporation, or even, in certain cases, by a combination of the two. The following are a few examples in which this issue might be relevant.

We mentioned the possibility that ROV-friendly handles could be provided on our clamps. Such handles could be molded into the plates, or machined into the plates during manufacturing. This would be a form of incorporation. Alternatively, a fastener, such as a hole, ring, or stud, could be molded or machined into a plate, and a handle could then be attached onto that fastener. This would be a form of attachment. Conceivably, a clamp, or even a single plate of a clamp, might have some handles that are included and other handles that are attached.

Another example would be the connection of tools to the clamps we have described. In FIG. 6A, we saw a two-piece clamp 30 which included a tool platform mounting bracket 42. Bolts were used to attach this bracket to a machine tool platform 44, and a milling machine 45 was then mounted on this platform. Clearly, however, it would be possible to include an equivalent platform, similar to 44, as an integral part of one or both plates of the clamp 30.

Bolt collars 35C, as shown in FIG. 17, would also present alternatives of this kind. The ones shown in the figure are integral to the plate. While we believe that integral bolt-collars are preferable for a number of reasons, it would certainly be possible to provide them by some form of attachment as well.

What is claimed is:

1. A clamshell-type clamp having one or more pieces, these pieces being here referred to as “plates”, said clamp being fabricated by means of a custom-manufacturing process so as to fit with precision onto certain selected surface portions of one or more selected pipes or other fluid-carrying objects, these pipes or fluid-carrying objects being here referred to as “fluid carriers” or as “target objects”, said selected surface portions being here referred to as “attachment regions”, and said process having the following sequential steps, or steps similar thereto:
a. a determination of the shape of said fluid carriers shall be made by methods chosen from a class of suitable methods, said class including but not limited to the following methods:
i. scanning of said fluid carriers by means of light, gamma rays, x-rays, or sonar,
ii. the creation of physical casts of said fluid carriers, and
iii. direct physical measurement of positions or relative positions of points on the surfaces of said fluid carriers, by mechanical or electromechanical means,
b. data expressing such determination of shape shall be converted into a format suitable for incorporation into the specification of a designed object, the shape of this object being determined by a mathematical representation using digital data, such data having a structure or format which may, after possible translation, be sent to a computer-controlled milling machine, or other electronically-controlled manufacturing device, so as to fabricate said designed object in physical form,
c. established methods of mechanical engineering, possibly making use of one or more computer-aided-design workstations, and also possibly making use of suitable software running on said workstations, shall be undertaken so as to create a specification for said clamp, and
d. said clamp shall then be manufactured, based on said specification, by means of an electronically-controlled manufacturing device, or other suitable means,
so that said clamp, in consequence of its design and manufacture, has the following features and properties:
1. each plate of said clamp is equipped with one or more flanges allowing it to be attached using bolts or other suitable fasteners to the other such plates in a specified pattern of such attachment, this pattern being part of the design of said clamp,
2. said plates may be moved into predetermined positions against the surfaces of said fluid carriers, such surface contact portions being generally the same as the above-mentioned attachment regions, said plates forming a precise fit against said surfaces, possibly making use of a gasket in order to achieve said precise fit, with said precise fit being adequate to achieve specified levels of fluid sealing and of mechanical rigidity in the contact between said plates and their respective attachment regions, such levels being achieved once said plates have been tightly fastened together with each other,
3. said clamp may include an optional enclosed region which envelopes specified portions of said fluid-carrying objects, said enclosed region possibly including optional extraction or auxiliary ports, said ports optionally having the shape of standard plumbing fixtures, the boundaries of said ports being comprised of portions of one or more of said plates, said ports and said plates being arranged in a configuration such that no appreciable movement of fluid is possible into or out of said region except via said ports or via the apertures of said fluid-carrying objects, said configuration being part of the intent and design of said clamp, and
4. said plates may be equipped with optional handles, such handles being provided by incorporation or by attachment, so as to allow easy assembly of said plates into said clamp by human beings, or by remote-controlled devices suitable to the intended context of installation for said clamp.

2. The clamp of claim 1, wherein said clamp has three or more plates, such a clamp being here referred to as a “3-or-more-plate clamp”, with each plate covering an angular span, on the attachment regions described in that claim, with such span being significantly less than 180 degrees in its angular extent, so that, in consequence of said limited angular span, the tangential component of the planned installation motion of said plate, with such tangency being in relation to the surface of the attachment region to be sealed by said plate, shall, in the course of said motion of said plate, be limited in its magnitude, with such limitation being valid at all points of said plate, so that, in consequence of such limitation, one or more of the following results may be true:
a. each of said plates will be less likely to jam than the plates of a 2-plate clamp, such 2-plate clamp being one that is designed to be applied to the same target object,
b. during the design phase of said 3-or-more-plate clamp, there will be greater flexibility in the choice of appropriate attachment regions, and in the choice of appropriate boundaries between the plates of said clamp, such greater flexibility being in comparison to a 2-plate clamp for the same target object, and
c. during installation, the requirements on the movement of said plates will be less stringent than such requirements would be for the plates of a 2-plate clamp designed for the same target object, the consequence of such less-stringent requirements being that
1. an installation process for said 3-or-more-plate clamp, undertaken by remotely-operated vehicles, or other remotely controlled installation devices, will be easier,
2. said installation process may also be faster, and
3. said installation process may also be more reliable in its resistance to jamming, and in its successful achievement of the proper placement of said plates,
so, that, in consideration of said results, clamps with 3 or more plates may be generally found to be preferable in certain ways to 2-plate clamps.

3. The clamp of claim 1, wherein some of the flanges of the plates of said clamp may be curved, these flanges being joined by bolts whose positioning and installation may be aided by the use of optional bolt-collars incorporated into or fastened onto said flanges, and, because of the inclusion of the possibility of curved flanges during the design phase of said clamp, there will be greater flexibility in the choice of appropriate attachment regions, and in the choice of appropriate boundaries between said plates, the result of such greater flexibility being that:
a. the design process for said clamp is potentially faster,
b. said clamp may have a better fit onto the target object or objects, and
c. said clamp may have less tendency to jam when installed,
wherein each of the immediately preceding three comparisons, a, b, and c, are in relation to a hypothetical alternative clamp, the flanges of which alternative clamp would be required to be flat.

4. The clamp of claim 1, further equipped with one or more tooling platforms, such platforms being provided by incorporation into the body of said clamp, or by attachment to said clamp using brackets or other fixtures, such platforms also having the means to support the mounting of tools, possibly including remotely-operated tools to be used for cutting, machining, or other purposes, so that, in relation to the target object or objects to which said clamp is attached, such object or objects being here referred to both singly and collectively as the “target”, one or both of the following conditions may obtain:
a. in virtue of the precise fit of said clamp against said target, and the rigid and stable mechanical relationship of said clamp with said target, a tool mounted on said tooling platform will have a mechanical relationship with said target of sufficient mechanical stability so as to allow for precise cuts or other modifications to be made upon said target by means of said tool, and
b. said mechanical stability in relationship to said target will also permit precise cuts or other modifications to be made by said tool upon another object which may be rigidly connected to said target,
so that such precise cuts or other modifications may potentially permit the achievement of goals or objectives which could not easily be achieved by other means, such goals or objectives including, for example, the tight sealing of an oil-containment device against a precisely cut or machined surface in a leaking pipe or other fluid-carrying object, such tight sealing serving to limit or reduce the oil released by an oil spill.

5. The clamp of claim 1, with said clamp, as well as the design, manufacture, and installation of said clamp, being part of a further risk-management strategy having one or more steps or elements similar to the following:
a. facilities for the design and fabrication of such clamps shall be created, in planning or in preparation for an emergency, such as an oil spill, this emergency being one in which custom-shaped fluid-containment fixtures may be needed,
b. in the event that an emergency or other circumstance occurs involving a release of fluid, and that, in such circumstance, certain leaking pipes, or other fluid-carrying objects, are found to have an irregular shape, such irregularity possibly being the result of breakage or other damage to such pipes or fluid-carrying objects, or if, possibly in consequence of such irregular shape, said fluid carriers cannot easily be attached to standard plumbing fixtures, or to other conventionally fabricated plumbing fixtures, then a device in the manner of said clamp shall be built, by the custom-manufacturing process described in claim 1, and
c. said device shall be installed on said fluid carriers, in such a manner that said device shall function as a plumbing adaptor by means of which said fluid carriers may be connected to standard plumbing fixtures, or connected to each other, such connection being performed in a fluid-tight way, the result of such fluid-tight connection being that, notwithstanding their possible irregular shape, such fluid carriers may nevertheless be included as part of a closed, fluid-tight system of plumbing equipment, such inclusion having a fluid-containment effect comparable to that which could normally be obtained by the connection of regular, standard, or undamaged plumbing components,
so that, in view of such steps or elements, said risk-management strategy may be seen to contribute toward an improved means of responding to possible future fluid-release emergencies, specifically including oil spill emergencies, such improved means having as their intended effects a benefit to public safety, to the economy, and to the protection of ecological resources, as generally called for in the January 2011 recommendations of the National Oil Spill Commission.

6. A method for making precise remote-controlled cuts in materials or equipment, such equipment possibly including damaged underwater oil-well pipes, or other oil-containing equipment, this method having the following features:
a. a remote-controlled milling machine is used to make the cuts,
b. the milling machine may be mounted on a robot or other remotely-operated device, such as an underwater remotely-operated vehicle, and
c. the milling machine may be supported by a custom-shaped clamp, designed to rigidly fit onto a portion of the damaged equipment, or other nearby equipment, this clamp optionally being fitted with or attached to a tooling platform on which said milling machine is mounted,
with the result of these features being that the quality of work done according to said method, with such quality reflected in speed, precision, reliability, resistance to the jamming of tools, and recovery from the jamming of tools, is preferable to that provided by a remote-controlled saw.

7. The method of claim 6, wherein said method is specifically applied to the task of containing oil from a leaking oil-well, at such a depth where remotely-operated-vehicles are generally used when working on oil-wells or related equipment.
